(19) United States
(12) Patent Application Publication
(10) Pub. No.: US 2004/0187079 A1
(43) Pub. Date: Sep. 23, 2004

(54) Layout system, layout program, and layout method

(75) Inventors: Satoshi Yamada, Suwa-shi (JP); Tsunemori Asahi, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 10/753,196

(22) Filed: Jan. 8, 2004

(30) Foreign Application Priority Data
Jan. 15, 2003 (JP) 2003-007221
Nov. 21, 2003 (JP) 2003-392043

(51) Int. Cl. G06F 15/00

(52) U.S. Cl. 715/517

(57) ABSTRACT

To provide a layout system which is suitable for preventing deviation from the layout intended by the designer and which is highly flexible in terms of layout.

When laying out a specific information storage frame setting up reference information, a content delivery terminal reads out a layout template from a template registration based on the reference information, regards the area identified by the size and placement location of the specific information storage frame as a layout area, places the information storage frame prescribed by the retrieved layout template in the area by contracting it, and stores an article in the placed information storage frame.

### BACKGROUND OF THE INVENTION

1. Field of the Invention

The present invention relates to a layout system, program, and method for laying out posting information such as a document, text and/or images that are posted (inserted) into a medium. More particularly, it relates to a layout system, layout program, and layout method which are suitable for preventing deviation from the layout intended by the designer and which are highly flexible in terms of layout.

2. Description of the Related Art

Conventionally, digital content delivery systems are available which provide digital content such as news to users. Generally, a digital content delivery system reads some pieces of digital content out of a content registration database (hereinafter a database will be abbreviated to DB), edits the retrieved digital content, and delivers the edited digital content to the user. In the process of editing digital content, the digital content is laid out so that the user can view it more easily. Layout techniques include, for example, a document processor disclosed in Patent Document 1 (hereinafter referred to as the first prior art example), a document processor disclosed in Patent Document 2 (hereinafter referred to as the second prior art example), and a layout setting method disclosed in Patent Document 3 (hereinafter referred to as the third prior art example).

According to the first prior art example, a partial-allocation template holder holds partial-allocation templates which represent rules for allocating partial logical structures obtained by classifying a document's logical structure held by a logical structure holder to a row of tree structures corresponding to each partial logical structure according to the predetermined relationships. The partial allocator makes partial allocations to a partial logical structure specified by a partial logical structure specification section, using a partial-allocation template corresponding to the partial logical structure. When finishing partial allocations to a partial logical structure and starting partial allocations to another partial logical structure, the partial allocator makes allocations to the entire logical structure of the document by making partial allocations through recursive calls to itself (recursive calls to the partial allocator). This makes it very simple and easy to create partial-allocation templates and allows existing allocation templates to be reused partially.

According to the second prior art example, a partial-allocation template holder holds partial-allocation templates which represent rules for allocating partial logical structures obtained by classifying a document's logical structure held by a logical structure holder corresponding to each partial logical structure according to predetermined relationships. A logical-allocation pair node manager maintains and manages combinations of nodes for use to hold information which specifies a predetermined partial logical structure in the logical structure and information which specifies a partial-allocation template corresponding to the predetermined partial logical structure by associating them with each other. The partial allocator makes allocations based on the nodes held by the logical-allocation pair node manager. The results of the allocations are held by an allocation structure holder. This makes it possible to change the logical structure of a document easily and improve the efficiency of allocation processes.

The third prior art example involves creating a template which includes a plurality of reference graphics for use to lay out character strings in different layout modes, copying the template to multiple locations on a single page of images, and thereby creating a plurality of template objects. The character strings to be laid out on each of the template objects are entered. Then, character strings are laid out on the plurality of reference graphics contained in each template object according to the layout mode of each reference graphic. This increases flexibility in the layout of character strings.

In the process of editing digital content, if layout is performed mechanically, viewability and appearance may be impaired significantly. Thus, designers prepare some layout patterns in advance and edit the digital content using the layout patterns to produce an intended layout. In this case, it is desired that an almost intended layout can be produced regardless of the contents, volume, and logical structure of the information to be posted.

However, both first and second prior art examples, which produce an overall layout by combining partial-allocation templates based on the logical structure of a document, may result in a layout not intended by the designer depending on the logical structure of the document although it may partially meet the designer's requirements.

Also, the third prior art example, which lays out character strings on a plurality of reference graphics contained in each template object according to the layout mode of each reference graphic, may result in a layout not intended by the designer depending on the entered character strings although layout flexibility is increased.

The present invention has been made in view of the unsolved problems with the conventional techniques. Its object is to provide a layout system, layout program, and layout method which are suitable for preventing deviation from the layout intended by the designer and which are highly flexible in terms of layout.

### SUMMARY OF THE INVENTION

(Embodiment 1)

To achieve the above object, embodiment 1 is a layout system including:

layout section for laying out posting information, the layout section performing layout by storing the posting information in information storage frames laid out in a predetermined layout area, according to a layout template which prescribes matters concerning the information storage frames for the layout area; and

template storage section for storing the layout template,

wherein a layout template can be set up for use instead of the information storage frames or for incorporation into the information storage frames,

the layout section reads the layout template in connection with the set up out of the template storage section and makes the retrieved layout template substituted for or incorporated into the information storage frames for which the layout template has been set up.

The term “posting information”, for example, may mean information such as a document, text and/or images that are posted (inserted) into a medium.

With this configuration, the layout section performs layout by storing posting information in information storage frames. If a layout template for use instead of the information storage frames or for incorporation into the information storage frames has been set up, the layout section reads the layout template in connection with the set up out of the template storage section and makes the retrieved layout template substituted for or incorporated into the information storage frames for which the layout template has been set up.

Consequently, the entire layout is performed according to the layout template. Regarding a specific information storage frame, its area is laid out according to the layout template set up for the information storage frame. Thus, once the designer prepares a desired layout template, an almost intended layout can be obtained whether in part or as a whole. This makes it possible to reduce the possibility of deviating from the layout intended by the designer regardless of the contents, volume, and logical structure of the information to be posted.

Incidentally, the information storage frame is a virtual frame which is located in a layout area and prescribes the area in which posting information constituting digital content is stored. Thus, it does not appear in layout results unless it is drawn visibly. Its shape is not prescribed particularly. Initial information storage frames are defined by layout templates (patterns) and the like. This also applies to the layout system in embodiment 2, layout programs in embodiments 18 and 19, and layout methods in embodiments 35 and 36.

The term “layout” means not only placement, but also so-called page layout for specifying arrangement of posted articles, character size, positions of plates, etc. This also applies to the layout system in embodiment 2, layout programs in embodiments 18 and 19, and layout methods in embodiments 35 and 36.

The layout template may be set up anywhere: for example, in an information storage frame, posting information, another layout template, a program, or an argument to the program. This also applies to the layout system in embodiment 2, layout programs in embodiments 18 and 19, and layout methods in embodiments 35 and 36.

The information storage frames for which the layout template has been set up (in this paragraph, such information storage frames will be referred to as specific information storage frames) may be placed either before or after storing posting information. In the former case, the information storage frames prescribed by the layout template are substituted for or incorporated into the specific information storage frames and the posting information is stored in the placed information storage frames. Conversely, to store the posting information first, the posting information is laid out in the information storage frames prescribed by the layout template and the layout results are substituted for or incorporated into the specific information storage frames. This also applies to the layout system in embodiment 2, layout programs in embodiments 18 and 19, and layout methods in embodiments 35 and 36.

The posting information includes character information, image information, and other information. This also applies to the layout system in embodiment 2, layout programs in embodiments 18 and 19, and layout methods in embodiments 35 and 36.

The term “layout,” for example, means display layout when laying our posting information to display it on screen and the term means print layout when laying our posting information to print it on paper. This also applies to the layout system in embodiment 2, layout programs in embodiments 18 and 19, and layout methods in embodiments 35 and 36.

The template storage section stores layout templates by any means at any time. It may either prestore layout templates or store them during the operation of the present system via external input or the like instead of prestoring them. This also applies to the layout system in embodiment 2, layout programs in embodiments 18 and 19, and layout methods in embodiments 35 and 36.

The present system may be implemented either as a single apparatus, terminal, or other device or as a network system which communicably connects a plurality of apparatus, terminals, or other devices. In the latter case, individual components may belong to any of the plurality of devices and the like as long as they are connected communicably. This also applies to the layout system in embodiment 2.

(Embodiment 2)

Embodiment 2 is a layout system including:

posting-information storage section for storing multiple pieces of posting information; template storage section for storing layout templates which prescribe, for a predetermined layout area, matters concerning information storage frames to be placed in the layout area; posting-information selection section for selecting posting information from the posting-information storage section; and layout section for laying out the posting information selected by the posting-information selection section, the layout section performing layout by storing the posting information in the information storage frames according to a layout template stored in the template storage section, wherein:

the information storage frames can set up reference information for referring to the layout template, and

when laying out the information storage frame setting up the reference information, the layout section reads out the layout template from the template storage section based on the reference information and makes the retrieved layout template substituted for or incorporated into the information storage frame containing the reference information.

With this configuration, posting-information selection section selects posting information from the posting-information storage section and the layout section performs layout by storing the posting information in a plurality of information storage frames. If an information storage frame contains the reference information, the layout section reads out the layout template from the template storage section based on the reference information and makes the retrieved layout template substituted for or incorporated into the information storage frame containing the reference information.

Consequently, the entire layout is performed according to the layout template. Regarding a specific information storage frame, its area is laid out according to the layout template set up for the information storage frame. Thus, once the designer prepares a desired layout template, an almost intended layout can be produced whether in part or as a whole. This makes it possible to reduce the possibility of deviating from the layout intended by the designer regardless of the contents, volume, and logical structure of the information to be posted.

The posting-information storage section stores posting information by any means at any time. It may either prestore posting information or store it during the operation of the present system via external input or the like instead of prestoring it.

(Embodiment 3)

Embodiment 3 is the layout system according to embodiment 2, wherein:

the layout template prescribes the sizes and placement locations of the information storage frames; and

the layout section regards an area identified by the size and placement location of the information storage frame containing the reference information as the layout area and places the information storage frames prescribed by the retrieved layout template in the area by expanding or contracting them.

With this configuration, the layout section regards an area identified by the size and placement location of the information storage frame containing the reference information as the layout area and places the information storage frames prescribed by the retrieved layout template in the area by expanding or contracting them.

(Embodiment 4)

Embodiment 4 is the layout system according to embodiment 3, wherein:

the layout section determines whether to incorporate the layout template into the information storage frame containing the reference information based on contents, volume, or logical structure of the posting information and if it determines to incorporate the layout template, it reads out the layout template from the template storage section based on the reference information and makes the retrieved layout template substituted for or incorporated into the information storage frame containing the reference information.

With this configuration, the layout section determines whether to incorporate the layout template into the information storage frame containing the reference information based on the contents, volume, or logical structure of the posting information. If the layout section determines to incorporate the layout template, it reads out the layout template from the template storage section based on the reference information and makes the retrieved layout template substituted for or incorporated into the information storage frame containing the reference information.

Consequently, if it is determined to incorporate the layout template based on the contents, volume, or logical structure of the posting information, the area of the information storage frame containing the reference information is laid out based on the layout template, but if it is determined not to incorporate the layout template based on the contents, volume, or logical structure of the posting information, the posting information is stored directly in the information storage frame containing the reference information. Thus layout can be performed relatively appropriately based on the contents, volume, or logical structure of the posting information.

(Embodiment 5)

Embodiment 5 is the layout system according to embodiment 4, wherein:

the posting information can set up an incorporation indicator which instructs the layout template to be incorporated; and

when the posting information sets up the incorporation indicator, the layout section reads out the layout template from the template storage section based on the reference information and makes the retrieved layout template substituted for or incorporated into the information storage frame containing the reference information.

With this configuration, when the posting information sets up the incorporation indicator, the layout section reads out the layout template from the template storage section based on the reference information and makes the retrieved layout template substituted for or incorporated into the information storage frame containing the reference information.

Since posting information can set up an incorporation indicator, incorporation of a layout template can be instructed relatively easily. This is suited for instructing a layout template to be incorporated depending on the contents, volume, or logical structure of the posting information.

(Embodiment 6)

Embodiment 6 is the layout system according to embodiment 4, wherein:

the layout template can set up an incorporation indicator which instructs the layout template to be incorporated; and

when the layout template sets up the incorporation indicator, the layout section reads out the layout template from the template storage section based on the reference information and makes the retrieved layout template substituted for or incorporated into the information storage frame containing the reference information.

With this configuration, when the layout template sets up the incorporation indicator, the layout section reads out the layout template from the template storage section based on the reference information and makes the retrieved layout template substituted for or incorporated into the information storage frame containing the reference information.

Since an incorporation indicator can be set up in a layout template, incorporation of the layout template can be instructed relatively easily.

(Embodiment 7)

Embodiment 7 is the layout system according to embodiment 4, wherein:

the layout section is constituted of a layout program which makes a computer execute processes implemented as the layout section; and

when an incorporation indicator which instructs the layout template to be incorporated is given as an argument, the layout program reads out the layout template from the template storage section based on the reference information and makes the retrieved layout template substituted for or incorporated into the information storage frame containing the reference information.

With this configuration, when an incorporation indicator is given as an argument, the layout program reads out the layout template from the template storage section based on the reference information and makes the retrieved layout template substituted for or incorporated into the information storage frame containing the reference information.

Since an incorporation indicator can be given as an argument, incorporation of the layout template can be instructed relatively easily.

(Embodiment 8)

Embodiment 8 is the layout system according to embodiment 4, wherein:

the layout template and the posting information can set up an incorporation indicator which instructs the layout template to be incorporated;

the layout section is constituted of a layout program which makes a computer execute processes implemented as the layout section;

when the incorporation indicator is set up in the layout template or the posting information or when the incorporation indicator is given as an argument, the layout program reads out the layout template from the template storage section based on the reference information and makes the retrieved layout template substituted for or incorporated into the information storage frame containing the reference information;

the layout program assigns priorities to setting in the layout template, setting in the posting information, or setting by the argument; and

when two or more settings are made from among the setting in the layout template, setting in the posting information, and setting by the argument, the layout program adopt one of the settings made, according to the priorities.

With this configuration, when the incorporation indicator is set up in the layout template or the posting information or when the incorporation indicator is given as an argument, the layout program reads out the layout template from the template storage section based on the reference information and makes the retrieved layout template substituted for or incorporated into the information storage frame containing the reference information. If two or more settings are made from among the setting in the layout template, setting in the posting information, and setting by the argument, the layout section adopt one of the settings made, according to the priorities.

Since the incorporation indicator can be set up in the layout template or posting information or given as an argument, incorporation of the layout template can be instructed relatively easily. Also, when two or more settings are made from among the setting in the layout template, setting in the posting information, and setting by the argument, even if they conflict with each other, one of the settings is adopted according to the priorities, further reducing the possibility of deviating from intended layout.

The priorities may be set anywhere: for example, in an information storage frame, posting information, a layout template, a program, or an argument to the program.

(Embodiment 9)

Embodiment 9 is the layout system according to any of embodiments 3 to 8, wherein:

the layout section regards the area identified by the size and placement location of the information storage frame containing the reference information as the layout area, places the information storage frames prescribed by the retrieved layout template in the area by expanding or contracting them, and performs layout by storing the posting information in the placed information storage frames.

With this configuration, the layout section regards the area identified by the size and placement location of the information storage frame containing the reference information as the layout area, places the information storage frames prescribed by the retrieved layout template in the area by expanding or contracting them, and stores the posting information in the placed information storage frames. Thus, the posting information is stored in the information storage frames into which the layout template has been incorporated.

(Embodiment 10)

Embodiment 10 is the layout system according to any of embodiments 3 to 8, wherein:

the layout section performs layout by expanding or contracting the information storage frames prescribed by the retrieved layout template according to the size and placement location of the information storage frame containing the reference information and by storing the posting information in the information storage frames, and places results of the layout in the area identified by the size and placement location of the information storage frame containing the reference information by regarding it as the layout area.

With this configuration, the layout section performs layout by expanding or contracting the information storage frames prescribed by the retrieved layout template according to the size and placement location of the information storage frame containing the reference information and by storing the posting information in the information storage frames. Then, the layout section places results of the layout in the area identified by the size and placement location of the information storage frame containing the reference information by regarding it as the layout area. Thus, the layout results are placed after the posting information is stored in the information storage frames prescribed by the layout template to be incorporated.

Incidentally, if the layout results are too large to fit in an information storage frame, the information storage frame is moved or other information storage frames are moved, expanded, or contracted. If the layout results still cannot fit in, the information storage frame is not placed on the page. This is because, expanding or contracting layout results involves changes in font size and the like, which in turn may impair layout. Thus, it is preferable to adjust the information storage frame in which the layout results are stored rather than to adjust the layout results.

(Embodiment 11)

Embodiment 11 is the layout system according to embodiment 9 or 10, wherein:

processing priority can be set to indicate which should be done first, the placement of the information storage frames or the storage of the posting information; and

if the layout section determines to place the information storage frames first based on the processing priority, it regards the area identified by the size and placement location of the information storage frame containing the reference information as the layout area, places the information storage frames prescribed by the retrieved layout template in the area by expanding or contracting them, and performs layout by storing the posting information in the placed information storage frames, but if the layout section determines to store the posting information first based on the processing priority, it performs layout by storing the posting information in the information storage frames prescribed by the retrieved layout template, and places results of the layout in the area identified by the size and placement location of the information storage frame containing the reference information by regarding it as the layout area.

With this configuration, if the processing priority indicates that information storage frames should be placed first, the layout section regards the area identified by the size and placement location of the information storage frame containing the reference information as the layout area, places the information storage frames prescribed by the retrieved layout template in the area by expanding or contracting them, and performs layout by storing the posting information in the placed information storage frames. Thus, the posting information is stored in the information storage frames into which the layout template has been incorporated.

On the other hand, if the processing priority indicates that posting information should be stored first, the layout section performs layout by storing the posting information in the information storage frames prescribed by the retrieved layout template, and places the results of the layout in the area identified by the size and placement location of the information storage frame containing the reference information by regarding it as the layout area. Thus, the layout results are placed after the posting information is stored in the information storage frames prescribed by the layout template to be incorporated.

Incidentally, if the layout results are too large to fit in an information storage frame, the information storage frame is moved or other information storage frames are moved, expanded, or contracted. If the layout results still cannot fit in, the information storage frame is not placed on the page. This is because, expanding or contracting layout results involves changes in font size and the like, which in turn may impair layout. Thus, it is preferable to adjust the information storage frame in which the layout results are stored rather than to adjust the layout results.

Thus, layout results may differ between when posting information is stored after placing information storage frames and when posting information is stored before placing information storage frames, but the use of processing priority makes it possible to specify the processing sequence which will produce appropriate layout results.

The processing priority may be set anywhere: for example, in an information storage frame, posting information, a layout template, a program, or an argument to the program.

(Embodiment 12)

Embodiment 12 is the layout system according to any of embodiments 3 to 11, wherein:

if an appropriate layout template does not exist in the template storage section, the layout section reads out a substitute for the layout template from the template storage section.

With this configuration, if an appropriate layout template does not exist in the template storage section, the layout section reads out a substitute for the layout template from the template storage section.

Consequently, if an appropriate layout template does not exist in the template storage section for some reason, a substitute layout template is read out, reducing the possibility of impairing the layout.

(Embodiment 13)

Embodiment 13 is the layout system according to any of embodiments 3 to 12, wherein:

the information storage frames include a character information storage frame, for which a lower font limit can be specified to indicate the lower limit of character size; and

when storing the posting information which is character information in the character information storage frame placed in the area identified by the size and placement location of the information storage frame containing the reference information, if the lower font limit has been specified for the character information storage frame, the layout section changes the shape of the character information storage frame by changing character size in the character information storage frame so that it will not fall below the lower font limit.

With this configuration, if a lower font limit has been specified for a character information storage frame, the layout section changes the shape of the character information storage frame by changing the character size in the character information storage frame so that it will not fall below the lower font limit.

Thus, the shape of the character information storage frame is changed so that the character size in the character information storage frame will not fall below the lower font limit, making it possible to reduce the possibility of deviating from the layout intended by the designer in terms of character size.

(Embodiment 14)

Embodiment 14 is the layout system according to any of embodiments 3 to 13, wherein:

the information storage frames include a character information storage frame, for which an upper font limit can be specified to indicate the upper limit of character size; and

when storing the posting information which is character information in the character information storage frame placed in the area identified by the size and placement location of the information storage frame containing the reference information, if the upper font limit has been specified for the character information storage frame, the layout section changes the shape of the character information storage frame by changing character size in the character information storage frame so that it will not exceed the upper font limit.

With this configuration, if an upper font limit has been specified for a character information storage frame, the layout section changes the shape of the character information storage frame by changing the character size in the character information storage frame so that it will not exceed the upper font limit.

Thus, the shape of the character information storage frame is changed so that the character size in the character information storage frame will not exceed the upper font limit, making it possible to reduce the possibility of deviating from the layout intended by the designer in terms of character size.

(Embodiment 15)

Embodiment 15 is the layout system according to any of embodiments 3 to 14, wherein:

if the aspect ratio of the area identified by the size and placement location of the information storage frame containing the reference information differs from the aspect ratio of the layout area prescribed by the retrieved layout template, the layout section changes the shape of the information storage frames to be placed in the area identified by the size and placement location of the information storage frame containing the reference information while maintaining the aspect ratio of the layout area prescribed by the retrieved layout template.

With this configuration, if the aspect ratio of the area identified by the size and placement location of the information storage frame containing the reference information differs from the aspect ratio of the layout area prescribed by the retrieved layout template, the layout section changes the shape of the information storage frames to be placed in the area identified by the size and placement location of the information storage frame containing the reference information while maintaining the aspect ratio of the layout area prescribed by the retrieved layout template.

Consequently, the aspect ratio of the layout area prescribed by the layout template is maintained, making it possible to further reduce the possibility of deviating from the layout intended by the designer.

(Embodiment 16)

Embodiment 16 is the layout system according to any of embodiments 3 to 15, including:

user information storage section for storing user information about users,

wherein the posting-information selection section selects the posting information from the posting-information storage section based on the user information in the user information storage section.

With this configuration, the posting-information selection section selects posting information from the posting-information storage section based on the user information in the user information storage section.

Consequently, since information unique to the user or information specified by the user is referred to when selecting posting information, it is possible to create content relatively in line with the user's wishes.

The user information includes, for example, the age, sex, taste, address, and name of the user as well as the operating environment of a user terminal. This also applies to the layout system in embodiment 17.

The user information storage section stores user information by any means at any time. It may either prestore user information or store it during the operation of the present system via external input or the like instead of prestoring it. This also applies to the layout system in embodiment 17.

(Embodiment 17)

Embodiment 17 is the layout system according to any of embodiments 3 to 15, including

user information storage section for storing user information about users,

wherein the layout section lays out the posting information selected by the posting-information selection section based on the user information in the user information storage section.

With this configuration, the layout section lays out the posting information selected by the posting-information selection section based on the user information in the user information storage section.

Consequently, since information unique to the user or information specified by the user is referred to in relation to layout, it is possible to create layout results relatively in line with the user's wishes.

When performing layout based on user information, if the user information includes age and if the user is a relatively elderly person, it is conceivable to use a relatively large font size for layout. Also, if the user information includes sex and if the user is a woman, it is conceivable to use roundish character fonts for layout. Also, when the user information includes taste, it is conceivable to adopt a layout in the style of a children's magazine, sport paper, or technical document according to the taste. Also, when the user information includes the address, it is conceivable to adopt a layout with a background of a landscape image peculiar to the location of the address. Also, when the user information includes the name, it is conceivable to adopt a layout using the name as a title. Also, when the user information includes the operating environment of a user terminal, if a RAM on the user terminal has a small capacity, it is conceivable to adopt a layout which involves minimal use of large-volume images.

(Embodiment 18)

On the other hand, to achieve the above object, embodiment 18 is a layout program for making a computer execute processes implemented as layout section for performing layout by storing posting information in information storage frames laid out in a predetermined layout area, according to a layout template which prescribes, for the layout area, matters concerning information storage frames, wherein:

a layout template can be set up for use instead of the information storage frames or for incorporation into the information storage frames,

the layout section reads the layout template in connection with the set up out of template storage section and makes the retrieved layout template substituted for or incorporated into the information storage frames for which the layout template has been set up.

When the program is read out and executed by the computer, this configuration offers effects equivalent to those of the layout system according to embodiment 1.

This offers effects equivalent to those of the layout system according to embodiment 1.

(Embodiment 19)

Embodiment 19 is a layout program which makes a computer execute processes implemented as:

posting-information selection section for selecting posting information from posting-information storage section storing multiple pieces of posting information; and layout section for performing layout by storing the posting information selected by the posting-information selection section in information storage frames according to a layout template which prescribes, for a predetermined layout area, matters concerning information storage frames to be placed in the layout area, wherein:

the information storage frames can set up reference information for referring to the layout template, and

when laying out the information storage frame containing the reference information, the layout section reads out the layout template from template storage section based on the reference information and makes the retrieved layout template substituted for or incorporated into the information storage frame containing the reference information.

When the program is read out and executed by the computer, this configuration performs operation and offers effects equivalent to those of the layout system according to embodiment 2.

(Embodiment 20)

Embodiment 20 is the layout program according to embodiment 19, wherein:

the layout template prescribes the sizes and placement locations of the information storage frames; and

the layout section regards an area identified by the size and placement location of the information storage frame containing the reference information as the layout area and places the information storage frames prescribed by the retrieved layout template in the area by expanding or contracting them.

When the program is read out and executed by the computer, this configuration performs operation and offers effects equivalent to those of the layout system according to embodiment 3.

(Embodiment 21)

Embodiment 21 is the layout program according to embodiment 20, wherein:

the layout section determines whether to incorporate the layout template into the information storage frame containing the reference information based on contents, volume, or logical structure of the posting information and if it determines to incorporate the layout template, it reads out the layout template from the template storage section based on the reference information and makes the retrieved layout template substituted for or incorporated into the information storage frame containing the reference information.

When the program is read out and executed by the computer, this configuration performs operation and offers effects equivalent to those of the layout system according to embodiment 4.

(Embodiment 22)

Embodiment 22 is the layout program according to embodiment 21, wherein

the posting information can set up an incorporation indicator which instructs the layout template to be incorporated; and

when the posting information sets up the incorporation indicator, the layout section reads out the layout template from the template storage section based on the reference information and makes the retrieved layout template substituted for or incorporated into the information storage frame containing the reference information.

When the program is read out and executed by the computer, this configuration performs operation and offers effects equivalent to those of the layout system according to embodiment 5.

(Embodiment 23)

Embodiment 23 is the layout program according to embodiment 21, wherein:

the layout template can set up an incorporation indicator which instructs the layout template to be incorporated; and

when the layout template sets up the incorporation indicator, the layout section reads out the layout template from the template storage section based on the reference information and makes the retrieved layout template substituted for or incorporated into the information storage frame containing the reference information.

When the program is read out and executed by the computer, this configuration performs operation and offers effects equivalent to those of the layout system according to embodiment 6.

(Embodiment 24)

Embodiment 24 is the layout program according to embodiment 21, wherein:

when an incorporation indicator which instructs the layout template to be incorporated is given as an argument, the layout section reads out the layout template from the template storage section based on the reference information and makes the retrieved layout template substituted for or incorporated into the information storage frame containing the reference information.

When the program is readout and executed by the computer, this configuration performs operation and offers effects equivalent to those of the layout system according to embodiment 7.

(Embodiment 25)

Embodiment 25 is the layout program according to embodiment 21, wherein:

the layout template and the posting information can set up an incorporation indicator which instructs the layout template to be incorporated;

when the incorporation indicator is set up in the layout template or the posting information or when the incorporation indicator is given as an argument, the layout section reads out the layout template from the template storage section based on the reference information and makes the retrieved layout template substituted for or incorporated into the information storage frame containing the reference information;

the layout section assigns priorities to setting in the layout template, setting in the posting information, and setting by the argument; and

when two or more settings are made from among the setting in the layout template, setting in the posting information, and setting by the argument, the layout section adopt one of the settings made, according to the priorities.

When the program is read out and executed by the computer, this configuration performs operation and offers effects equivalent to those of the layout system according to embodiment 8.

(Embodiment 26)

Embodiment 26 is the layout program according to any of embodiments 20 to 25, wherein:

the layout section regards the area identified by the size and placement location of the information storage frame containing the reference information as the layout area, places the information storage frames prescribed by the retrieved layout template in the area by expanding or contracting them, and performs layout by storing the posting information in the placed information storage frames.

When the program is read out and executed by the computer, this configuration performs operation and offers effects equivalent to those of the layout system according to embodiment 9.

(Embodiment 27)

Embodiment 27 is the layout program according to any of embodiments 20 to 25, wherein:

the layout section performs layout by expanding or contracting the information storage frames prescribed by the retrieved layout template according to the size and placement location of the information storage frame containing the reference information and by storing the posting information in the information storage frames, and places results of the layout in the area identified by the size and placement location of the information storage frame containing the reference information by regarding it as the layout area.

When the program is read out and executed by the computer, this configuration performs operation and offers effects equivalent to those of the layout system according to embodiment 10.

(Embodiment 28)

Embodiment 28 is the layout program according to embodiment 26 or 27, wherein:

processing priority can be set to indicate which should be done first, the placement of the information storage frames or the storage of the posting information; and

if the layout section determines to place the information storage frames first based on the processing priority, it regards the area identified by the size and placement location of the information storage frame containing the reference information as the layout area, places the information storage frames prescribed by the retrieved layout template in the area by expanding or contracting them, and performs layout by storing the posting information in the placed information storage frames, but if the layout section determines to store the posting information first based on the processing priority, it performs layout by storing the posting information in the information storage frames prescribed by the retrieved layout template, and places results of the layout in the area identified by the size and placement location of the information storage frame containing the reference information by regarding it as the layout area.

When the program is readout and executed by the computer, this configuration performs operation and offers effects equivalent to those of the layout system according to embodiment 11.

(Embodiment 29)

Embodiment 29 is the layout program according to any of embodiments 20 to 28, wherein:

if an appropriate layout template does not exist in the template storage section, the layout section reads out a substitute for the layout template from the template storage section.

When the program is read out and executed by the computer, this configuration performs operation and offers effects equivalent to those of the layout system according to embodiment 12.

(Embodiment 30)

Embodiment 30 is the layout program according to any of embodiments 20 to 29, wherein:

the information storage frames include a character information storage frame, for which a lower font limit can be specified to indicate the lower limit of character size; and

when storing the posting information which is character information in the character information storage frame placed in the area identified by the size and placement location of the information storage frame containing the reference information, if the lower font limit has been specified for the character information storage frame, the layout section changes the shape of the character information storage frame by changing character size in the character information storage frame so that it will not fall below the lower font limit.

When the program is readout and executed by the computer, this configuration performs operation and offers effects equivalent to those of the layout system according to embodiment 13.

(Embodiment 31)

Embodiment 31 is the layout program according to any of embodiments 20 to 30, wherein:

the information storage frames include a character information storage frame, for which an upper font limit can be specified to indicate the upper limit of character size; and

when storing the posting information which is character information in the character information storage frame placed in the area identified by the size and placement location of the information storage frame containing the reference information, if the upper font limit has been specified for the character information storage frame, the layout section changes the shape of the character information storage frame by changing character size in the character information storage frame so that it will not exceed the upper font limit.

When the program is read out and executed by the computer, this configuration performs operation and offers effects equivalent to those of the layout system according to embodiment 14.

(Embodiment 32)

Embodiment 32 is the layout program according to any of embodiments 20 to 31, wherein:

if the aspect ratio of the area identified by the size and placement location of the information storage frame containing the reference information differs from the aspect ratio of the layout area prescribed by the retrieved layout template, the layout section changes the shape of the information storage frames to be placed in the area identified by the size and placement location of the information storage frame containing the reference information while maintaining the aspect ratio of the layout area prescribed by the retrieved layout template.

When the program is read out and executed by the computer, this configuration performs operation and offers effects equivalent to those of the layout system according to embodiment 15.

(Embodiment 33)

Embodiment 33 is the layout program according to any of embodiments 20 to 32, wherein:

the posting-information selection section selects the posting information from the posting-information storage section based on user information in user information storage section which stores user information about users.

When the program is read out and executed by the computer, this configuration performs operation and offers effects equivalent to those of the layout system according to embodiment 16.

(Embodiment 34)

Embodiment 34 is the layout program according to any of embodiments 20 to 32, wherein:

the layout section lays out the posting information selected by the posting-information selection section based on user information in user information storage section which stores user information about users.

When the program is read out and executed by the computer, this configuration performs operation and offers effects equivalent to those of the layout system according to embodiment 17.

(Embodiment 35)

On the other hand, to achieve the above object, embodiment 35 is a layout method including:

a layout step of laying out posting information, the layout step performing layout by storing the posting information in information storage frames laid out in a predetermined layout area, according to a layout template which prescribes matters concerning the information storage frames for the layout area;

a template storage step of storing the layout template in template storage section; and

a layout template setting up step of setting up a layout template for use instead of the information storage frames or for incorporation into the information storage frames,

wherein the layout step reads out the layout template in connection with the set up out of the template storage section and makes the retrieved layout template substituted for or incorporated into the information storage frames for which the layout template has been set up.

This offers effects equivalent to those of the layout system according to embodiment 1.

(Embodiment 36)

Embodiment 36 is a layout method including: a posting information storage step of storing multiple pieces of posting information in posting-information storage section; a template storage step of storing, in template storage section, a layout template which prescribes, for a predetermined layout area, matters concerning information storage frames to be placed in the layout area; a posting information selection step of selecting posting information from the posting-information storage section; and a layout step of laying out the posting information selected in the posting information selection step, the layout step performing layout by storing the posting information in the information storage frames according to a layout template stored in the template storage section, wherein:

the information storage frames can set up reference information for referring to the layout template, and

when laying out the information storage frame containing the reference information, the layout step reads out the layout template from the template storage section based on the reference information and makes the retrieved layout template substituted for or incorporated into the information storage frame containing the reference information.

This offers effects equivalent to those of the layout system according to embodiment 2.

(Embodiment 37)

Embodiment 37 is the layout method according to embodiment 36, wherein:

the layout template prescribes the sizes and placement locations of the information storage frames; and

the layout step regards an area identified by the size and placement location of the information storage frame containing the reference information as the layout area and places the information storage frames prescribed by the retrieved layout template in the area by expanding or contracting them.

This offers effects equivalent to those of the layout system according to embodiment 3.

(Embodiment 38)

Embodiment 38 is the layout method according to embodiment 37, wherein:

the layout step determines whether to incorporate the layout template into the information storage frame containing the reference information based on contents, volume, or logical structure of the posting information and if it determines to incorporate the layout template, it reads out the layout template from the template storage section based on the reference information and makes the retrieved layout template substituted for or incorporated into the information storage frame containing the reference information.

This offers effects equivalent to those of the layout system according to embodiment 4.

(Embodiment 39)

Embodiment 39 is the layout method according to embodiment 38, wherein:

the posting information can set up an incorporation indicator which instructs the layout template to be incorporated; and

when the posting information sets up the incorporation indicator, the layout step reads out the layout template from the template storage section based on the reference information and makes the retrieved layout template substituted for or incorporated into the information storage frame containing the reference information.

This offers effects equivalent to those of the layout system according to embodiment 5.

(Embodiment 40)

Embodiment 40 is the layout method according to embodiment 38, wherein:

the layout template can set up an incorporation indicator which instructs the layout template to be incorporated; and

when the layout template sets up the incorporation indicator, the layout step reads out the layout template from the template storage section based on the reference information and makes the retrieved layout template substituted for or incorporated into the information storage frame containing the reference information.

This offers effects equivalent to those of the layout system according to embodiment 6.

(Embodiment 41)

Embodiment 41 is the layout method according to embodiment 38, wherein:

the layout step executes a layout program which makes a computer execute a layout process; and

when an incorporation indicator which instructs the layout template to be incorporated is given as an argument, the layout program reads out the layout template from the template storage section based on the reference information and makes the retrieved layout template substituted for or incorporated into the information storage frame containing the reference information.

This offers effects equivalent to those of the layout system according to embodiment 7.

(Embodiment 42)

Embodiment 42 is the layout method according to embodiment 38, wherein:

the layout template and the posting information can set up an incorporation indicator which instructs the layout template to be incorporated;

the layout step executes a layout program which makes a computer execute a layout process; and

when the incorporation indicator is set up in the layout template or the posting information or when the incorporation indicator is given as an argument, the layout program reads out the layout template from the template storage section based on the reference information and makes the retrieved layout template substituted for or incorporated into the information storage frame containing the reference information;

priorities are assigned to setting in the layout template, setting in the posting information, or setting by the argument; and

when two or more settings are made from among the setting in the layout template, setting in the posting information, and setting by the argument, the layout program adopt one of the settings made, according to the priorities.

This offers effects equivalent to those of the layout system according to embodiment 8.

(Embodiment 43)

Embodiment 43 is the layout method according to any of embodiments 37 to 42, wherein:

the layout step regards the area identified by the size and placement location of the information storage frame containing the reference information as the layout area, places the information storage frames prescribed by the retrieved layout template in the area by expanding or contracting them, and performs layout by storing the posting information in the placed information storage frames.

This offers effects equivalent to those of the layout system according to embodiment 9.

(Embodiment 44)

Embodiment 44 is the layout method according to any of embodiments 37 to 42, wherein:

the layout step performs layout by expanding or contracting the information storage frames prescribed by the retrieved layout template according to the size and placement location of the information storage frame containing the reference information and by storing the posting information in the information storage frames, and places results of the layout in the area identified by the size and placement location of the information storage frame containing the reference information by regarding it as the layout area.

This offers effects equivalent to those of the layout system according to embodiment 10.

(Embodiment 45)

Embodiment 45 is the layout method according to embodiment 43 or 44, wherein:

processing priority can be set to indicate which should be done first, the placement of the information storage frames or the storage of the posting information; and

if the layout step determines to place the information storage frames first based on the processing priority, it regards the area identified by the size and placement location of the information storage frame containing the reference information as the layout area, places the information storage frames prescribed by the retrieved layout template in the area by expanding or contracting them, and performs layout by storing the posting information in the placed information storage frames, but if the layout step determines to store the posting information first based on the processing priority, it performs layout by storing the posting information in the information storage frames prescribed by the retrieved layout template, and places results of the layout in the area identified by the size and placement location of the information storage frame containing the reference information by regarding it as the layout area.

This offers effects equivalent to those of the layout system according to embodiment 11.

(Embodiment 46)

Embodiment 46 is the layout method according to any of embodiments 37 to 45, wherein:

if an appropriate layout template does not exist in the template storage section, the layout step reads out a substitute for the layout template from the template storage section.

This offers effects equivalent to those of the layout system according to embodiment 12.

(Embodiment 47)

Embodiment 47 is the layout method according to any of embodiments 37 to 46, wherein:

the information storage frames include a character information storage frame, for which a lower font limit can be specified to indicate the lower limit of character size; and

when storing the posting information which is character information in the character information storage frame placed in the area identified by the size and placement location of the information storage frame containing the reference information, if the lower font limit has been specified for the character information storage frame, the layout step changes the shape of the character information storage frame by changing character size in the character information storage frame so that it will not fall below the lower font limit.

This offers effects equivalent to those of the layout system according to embodiment 13.

(Embodiment 48)

Embodiment 48 is the layout method according to any of embodiments 37 to 47, wherein:

the information storage frames include a character information storage frame, for which an upper font limit can be specified to indicate the upper limit of character size; and

when storing the posting information which is character information in the character information storage frame placed in the area identified by the size and placement location of the information storage frame containing the reference information, if the upper font limit has been specified for the character information storage frame, the layout step changes the shape of the character information storage frame by changing character size in the character information storage frame so that it will not exceed the upper font limit.

This offers effects equivalent to those of the layout system according to embodiment 14.

(Embodiment 49)

Embodiment 49 is the layout method according to any of embodiments 37 to 48, wherein:

if the aspect ratio of the area identified by the size and placement location of the information storage frame containing the reference information differs from the aspect ratio of the layout area prescribed by the retrieved layout template, the layout step changes the shape of the information storage frames to be placed in the area identified by the size and placement location of the information storage frame containing the reference information while maintaining the aspect ratio of the layout area prescribed by the retrieved layout template.

This offers effects equivalent to those of the layout system according to embodiment 15.

(Embodiment 50)

Embodiment 50 is the layout method according to any of embodiments 37 to 49, including:

a user information storage step of storing user information in user information storage section which stores user information about users,

wherein the posting information selection step selects posting information from the posting-information storage section based on the user information in the user information storage section.

This offers effects equivalent to those of the layout system according to embodiment 16.

(Embodiment 51)

Embodiment 51 is the layout method according to any of embodiments 37 to 49, including:

a user information storage step of storing user information in user information storage section which stores user information about users;

the layout step lays out the posting information selected in the posting information selection step based on the user information in the user information storage section.

This offers effects equivalent to those of the layout system according to embodiment 17.

### BRIEF DESCRIPTION OF THE DRAWINGS

FIG. 1 is a block diagram showing configuration of a network system to which embodiments of the invention are applied;

FIG. 2 is a functional block diagram outlining functions of a content delivery terminal 100;

FIG. 3 is a block diagram showing configuration of the content delivery terminal 100;

FIG. 4 is a diagram showing data structure of a user profile table 300;

FIGS. 5A and 5B are diagrams showing layout templates and data structure of a layout template table 330;

FIG. 6 is a diagram showing part of data structure of a layout template;

FIGS. 7A and 7B are diagrams showing digital content and data structure of a category table 340;

FIG. 8 is a flowchart showing a user registration process;

FIG. 9 is a flowchart showing a content delivery process;

FIG. 10 is a flow chart showing an automatic layout process;

FIGS. 11A to 11E are diagrams illustrating a process of layout;

FIG. 12 is a diagram showing data structure of a layout template which prescribes a specific information storage frame;

FIG. 13 is a diagram showing data structure of a layout template which prescribes a specific information storage frame;

FIG. 14 is a diagram showing data structure of a layout template incorporated into a specific information storage frame;

FIG. 15 is a diagram showing data structure of a layout template which prescribes a specific information storage frame;

FIG. 16 is a diagram showing data structure of a layout template in which a lower font limit and upper font limit are specified;

FIG. 17 is a diagram illustrating a process of layout performed with a lower font limit and upper font limit specified;

FIG. 18 is a diagram showing data structure of a layout template in which a lower font limit and upper font limit are specified;

FIGS. 19A to 19C are diagrams illustrating a process of layout performed when a layout template which prescribes an image information storage frame is incorporated;

FIG. 20 is a diagram showing data structure of a layout template incorporated into a specific information storage frame;

FIG. 21 is a diagram showing data structure of a layout template which prescribes a specific information storage frame;

FIG. 22 is a diagram showing data structure of a plurality of layout templates which are incorporated selectively;

FIGS. 23A to 23D are diagrams illustrating a process of layout performed when priorities are assigned to multiple settings;

FIGS. 24A to 24F are diagrams illustrating a process of layout performed when the size of a specific information storage frame is changed;

FIGS. 25A and 25B are diagrams illustrating layout processes which differ in the order of placement and storage;

FIG. 26 is a diagram showing data structure of content in which a template for font replacement is set up; and

FIG. 27 is a diagram illustrating a process of layout performed when the template for font replacement is set up.

### DETAILED DESCRIPTION OF THE PREFERRED EMBODIMENTS

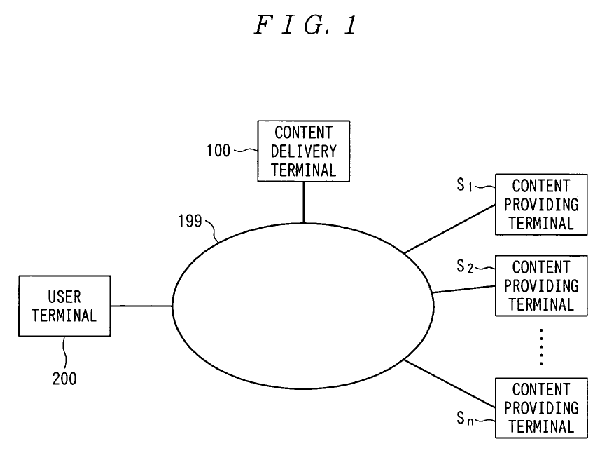

Embodiments of the present invention will be described below with reference to the drawings. FIGS. 1 to 11 are diagrams showing embodiments of a layout system, layout program, and layout method according to the present invention.

In this embodiment, the layout system, layout program, and layout method according to the present invention are applied to a case in which a content delivery terminal 100 delivers digital content such as news to a user terminal 200 as shown in FIG. 1.

First, configuration of a network system to which the present invention is applied will be described with reference to FIG. 1. FIG. 1 is a block diagram showing the configuration of the network system to which the present invention is applied.

The Internet 199 is connected with a plurality of content providing terminals S1 to Sn, the content delivery terminal 100 which collects, accumulates, and delivers digital content provided by the content providing terminals S1 to Sn (hereinafter, the digital content provided by the content providing terminals S1 to Sn may be referred to as article information or articles), and the user terminal 200 for use by the user as shown in FIG. 1. Incidentally, although only one user terminal 200 is shown in the figure to facilitate understanding of the invention, actually more than one user terminal is connected to the Internet 199.

The content providing terminals S1 to Sn have the same capabilities as a typical computer equipped with a CPU, a ROM, a RAM, interfaces, etc. which are connected via a bus. When they create digital content, they deliver it to the content delivery terminal 100 by attaching a category No. for identification of the digital content. Incidentally, the category number will be described in detail later.

The user terminal 200 has the same capabilities as a typical computer equipped with a CPU, a ROM, a RAM, interfaces, etc. which are connected via a bus. It is equipped with a WWW (World Wide Web) browser to access the content delivery terminal 100.

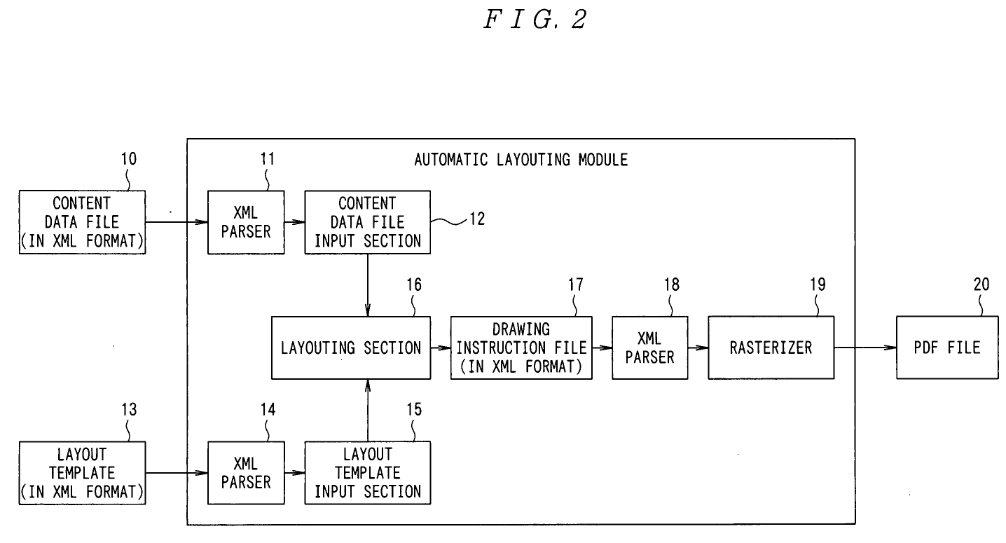

Next, functions of the content delivery terminal 100 will be outlined with reference to FIG. 2. FIG. 2 is a functional block diagram outlining the functions of the content delivery terminal 100.

As shown in FIG. 2, the content delivery terminal 100 includes an XML parser 11 which parses content data files 10 in XML (extensible Markup Language) format, a content data file input section 12 which is fed the content data files 10 parsed by the XML parser 11, an XML parser 14 which parses XML layout templates 13 in XML format, a layout template input section 15 which is fed the layout templates 13 parsed by the XML parser 14, a layouting section 16 which performs layout based on the content data files 10 and layout templates 13 entered via the input sections 12 and 15, an XML parser 18 which parses a drawing instruction file 17 in XML format received from the layouting section 16, rasterizer 19 which draws based on the drawing instruction file 17 parsed by the XML parser 18 and thereby creates a file 20 in PDF (Portable Document Format). From among the above components, this embodiment is characterized by the layouting section 16.

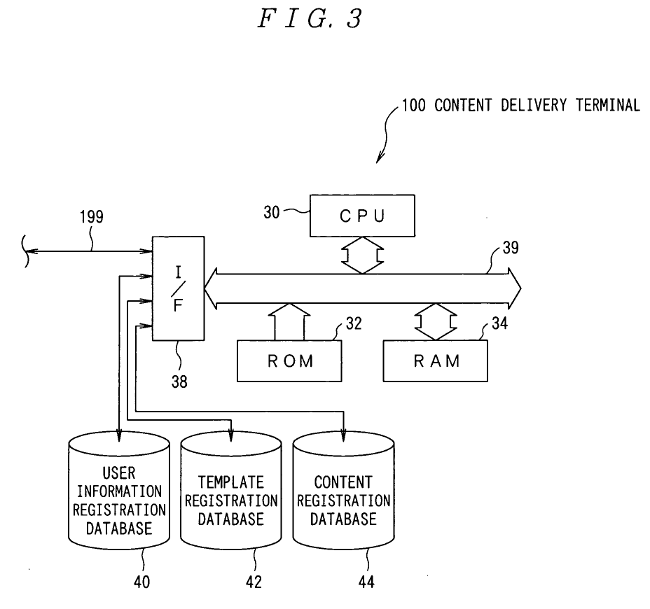

Next, configuration of the content delivery terminal 100 will be described in detail with reference to FIG. 3. FIG. 3 is a block diagram showing the configuration of the content delivery terminal 100.

As shown in FIG. 3, the content delivery terminal 100 includes a CPU 30 which performs computational operations and controls the entire system based on a control program, a ROM 32 for prestoring the control program of the CPU 30 in a predetermined area, a RAM 34 for storing data read out of the ROM 32 and computational results needed in the computational processes of the CPU 30, and an I/F 38 which mediates input and output of data from/to external equipment, all of which are interconnected via a bus 39—which is a signal line for data transfer—to allow data exchange among them.

The I/F 38 is connected with a user information registration DB 40 used to register user information, template registration DB 42 used to register layout templates which prescribe layout frames, content registration DB 44 used to collect and accumulate digital content provided by the content providing terminals S1 to Sn, and signal line used to connect to the Internet 199.

Next, data structure of the user information registration DB 40 will be described with reference to a drawing.

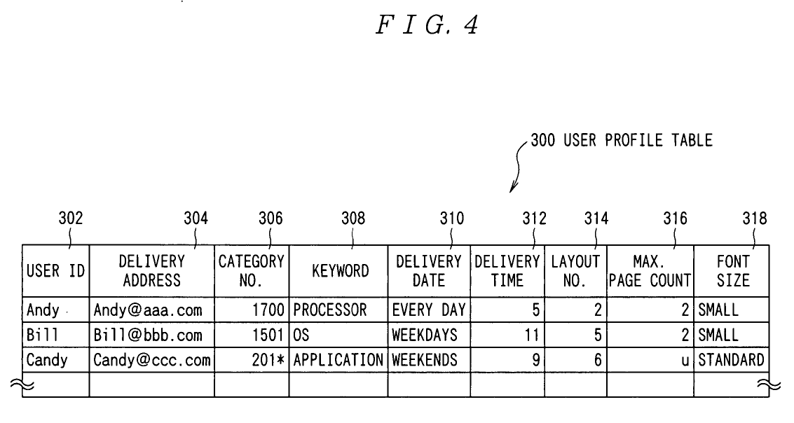

As shown in FIG. 4, the user information registration DB 40 stores a user profile table 300 used to register user information. FIG. 4 is a diagram showing data structure of the user profile table 300.

As shown in FIG. 4, the user profile table 300 can register one or more records for each user. Each record registers a field 302 for entering a user ID which is used to identify a user, field 304 for entering a delivery address for digital content, field 306 for entering a category number, field 308 for entering a keyword, field 310 for entering a delivery date, field 312 for entering a delivery time, field 314 for entering a layout number, field 316 for entering a maximum page count, and field 318 for entering a font size.

The field 308 registers a keyword specified by the user when digital content containing the keyword is selected to be delivered. Possible keywords include, for example, those likely to be encountered frequently in articles which belong to a category the user is interested in. In the example of FIG. 4, “Processor” and “OS” (Operating System) are registered in the first and second rows of the field 308, respectively.

The field 310 registers the delivery date on which the user wants digital content to be delivered. If the user wants digital content to be delivered every day, he/she specifies “Every Day;” if he/she wants digital content to be delivered on Weekdays, he/she specifies “Weekdays;” and if he/she wants digital content to be delivered on Weekends, he/she specifies “Weekends.” In the example of FIG. 4, “Every Day” and “Weekdays” are registered in the first and second rows of the field 310, respectively.

The field 312 registers the delivery time at which the user wants digital content to be delivered. For example, this field specifies a desired time of the day between 0 and 23 o'clock in 24-hour format. In the example of FIG. 4, “5” o'clock and “11” o'clock are registered in the first and second rows of the field 312, respectively.

The field 314 registers the layout number which identifies output layout of digital content. The field specifies, for example, the layout number used to identify the output layout desired by the user. In the example of FIG. 4, layout numbers “2” and “5” are registered in the first and second rows of the field 314, respectively. The layout numbers will be described in detail later.

The field 316 registers the maximum page count which is used as the upper limit when digital content is displayed or printed. Available values of this field include not only the maximum page count used as the upper limit, but also “u” which indicates that no upper limit is specified. In the example of FIG. 4, “2” and “u” are registered in the first and third rows of the field 316, respectively.

The field 318 registers the font size used to display or print digital content. In the example of FIG. 4, “small” and “standard” are registered in the first and third rows of the field 318, respectively.

Next, data structure of the template registration DB 42 will be described in detail with reference to a drawing.

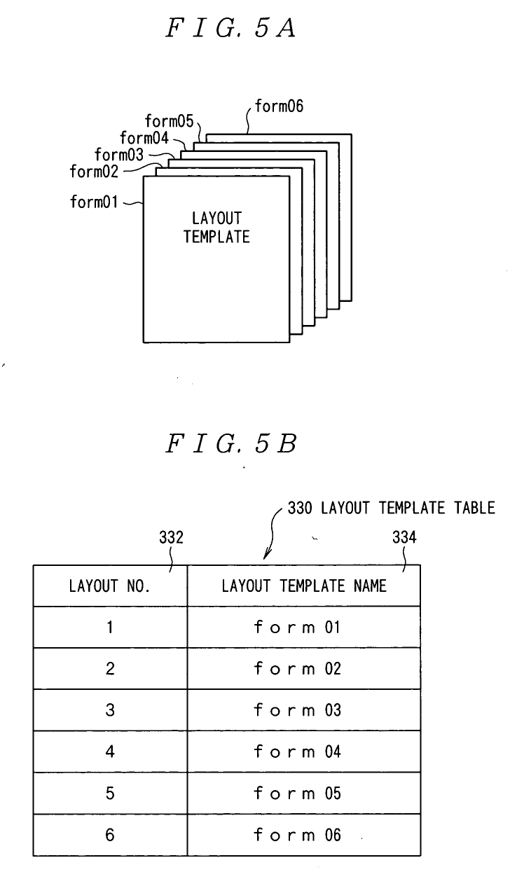

As shown in FIGS. 5A and 5B, the template registration DB 42 stores layout templates form01 to form06 which prescribe output layouts of digital content as well as a layout template table 330 which lists the layout templates form01 to form06 together with corresponding layout numbers. FIGS. 5A and 5B are diagrams showing the layout templates and data structure of the layout template table 330.

The layout templates form01 to form06 prescribe, for example, the sizes of character information storage frames which store character information; sizes of images contained in digital content; placement locations of the character information storage frames and images on print paper; the sizes, types, and colors of fonts for the character information; character spacing and line spacing; and the numbers, quality, sizes, and ratios of images. They are written in XML or the like.

As shown in FIG. 5B, the layout template table 330 registers one record per layout number. Each record has a field 332 which registers a layout number and a field 334 which registers a file name of a layout template. In the example of FIG. 5B, the record in the first row registers layout number “1” and layout template name “form01” while the record in the second row registers layout number “2” and layout template name “form02.”

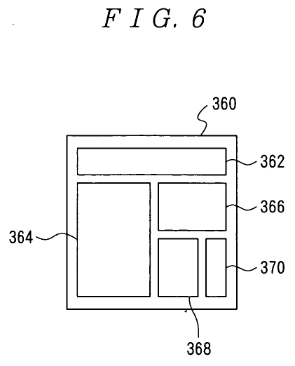

Next, data structure of the layout templates form01 to form06 will be described in detail with reference to FIG. 6. FIG. 6 is a diagram showing part of data structure of a layout template. Incidentally, although the layout templates form01 to form06 have different data structures, only a representative of the layout templates form01 to form06 will be described here.

The layout template form01 has a layout area 360 for each page and prescribes frames laid out in the layout area 360, including a title information storage frame 362 for storing title information, character information storage frame 364 for storing character information, image information storage frame 366 for storing image information, image information storage frame 368, and character information storage frame 370, for example, as shown in FIG. 6. Also, although not shown, if character information overflows the character information storage frame, an additional character information storage frame may be provided in the layout area 360 solely to accommodate the overflow (hereinafter such a frame may be referred to as an overflow storage frame). Of course, unused character information storage frames may be used as overflow storage frame. Hereinafter, the character information which has overflowed on the current page or previous pages and other overflowing information will be referred to as overflowed objects. Incidentally, FIG. 6 is merely exemplary, and the shape, size, and number of character information storage frames as well as their placement locations in the layout area 360 vary with each layout template.

If an information storage frame can be substituted with or incorporate another layout template, to incorporate a layout template, the information storage frame sets up reference information (a layout number) for use to refer to the layout template. For example, if the information storage frame sets up reference information “2,” the layout template form02 corresponding to the layout number “2” is read out and the information storage frame prescribed by the retrieved layout template is substituted for or placed in the information storage frame (hereinafter referred to as a specific information storage frame) setting up the reference information. Incidentally, whether to incorporate a layout template is specified by an incorporation indicator set up in article information, but this will be described in detail later.

Next, data structure of the content registration DB 44 will be described in detail with reference to drawings.

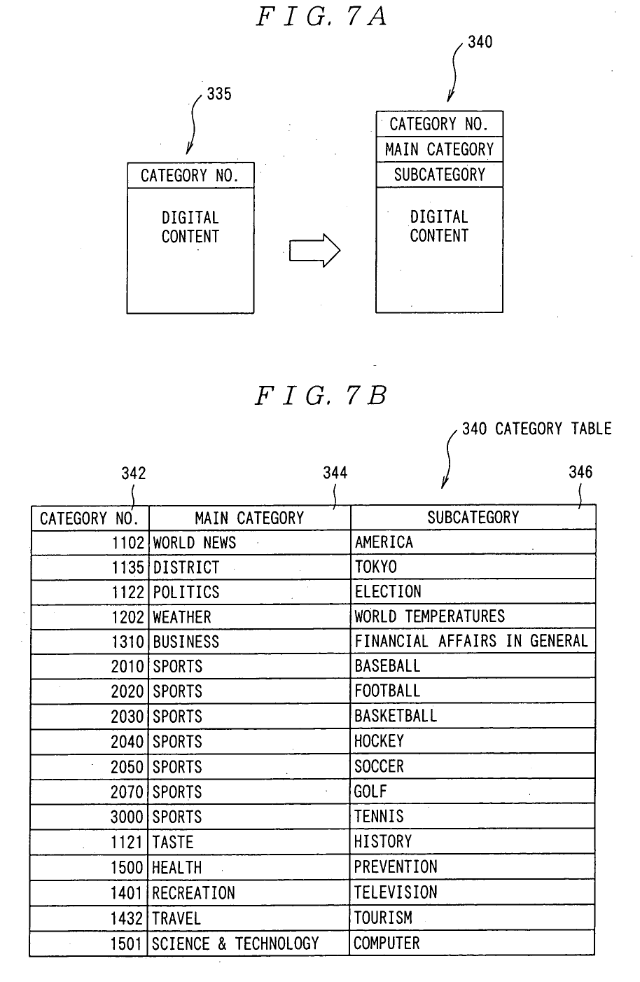

As shown in FIGS. 7A and 7B, the content registration DB 44 stores the digital content provided by the content providing terminals S1 to Sn as well as a category table 340 which represents correspondence among main categories, subcategories, and category numbers. FIGS. 7A and 7B are diagrams showing digital content and data structure of the category table 340.

As shown in FIG. 7A, the digital content 335 provided by the content providing terminals S1 to Sn has an article number and category number attached. The content delivery terminal 100 classifies digital content into categories based on the category numbers and registers it in the content registration DB 44. In addition to the article number and category number, the main category and subcategory are registered together with the digital content with reference to the category table 340. Also, the digital content is configured as an article containing title information which represents the title of the article, image information which provides images in the article, and character information which provides sentences in the article. Also, the digital content can set up an incorporation indicator which instructs a layout template to be incorporated into an information storage frame. To incorporate a layout template into an information storage frame, the digital content sets up the incorporation indicator. Specifically, when storing digital content into specific information storage frames, if the digital content sets up the incorporation indicator, the information storage frames prescribed by the layout template are substituted for or incorporated into the specific information storage frames and the digital content is stored in the placed information storage frames.

As shown in FIG. 7B, the category table 340 registers one record for each main category and subcategory. Each record contains a category number field 342, main category field 344, and subcategory field 346. In the example of FIG. 7B, the record in the first row registers “1102” as the category number, “World News” as the main category, and “America” as the subcategory while the record in the sixth row registers “2010” as the category number, “Sports” as the main category, and “Baseball” as the subcategory.

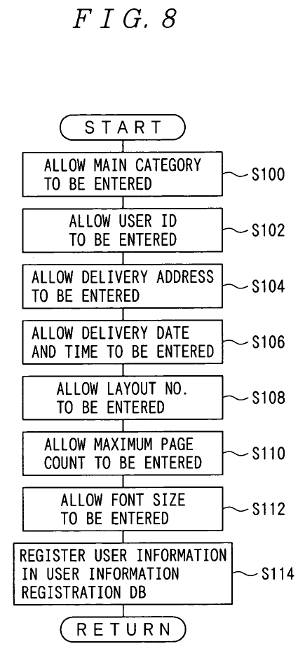

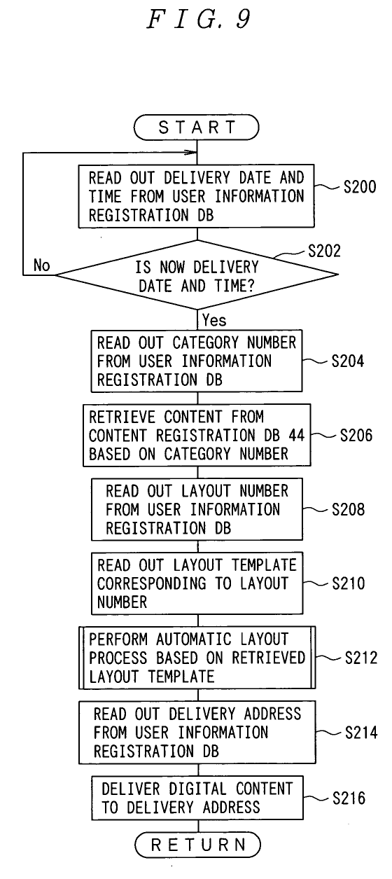

Next, configuration of the CPU 30 and processes performed by the CPU 30 will be described with reference to FIGS. 8 and 9.

The CPU 30 includes a microprocessing unit (MPU), etc. It starts a predetermined program stored in a predetermined area of the ROM 32 and performs a user registration process and content delivery process shown in flowcharts of FIGS. 8 and 9 on a time-shared basis according to the program.

First, the user registration process will be described in detail with reference to FIG. 8. FIG. 8 is a flowchart showing the user registration process.

The user registration process involves prompting an accessing user to enter necessary user information such as a user ID and registering the entered user information in the user profile table 300. It is performed by the CPU 30, beginning with Step S100 as shown in FIG. 8. Incidentally, in the following steps, all inputs are entered interactively with the user.

The CPU 30 allows the user to enter a main category and subcategory in Step S100, a user ID and password in Step S102, a delivery address in Step S104, and a delivery date and delivery time in Step S106. Then, the CPU 30 goes to Step S108.

The CPU 30 allows the user to enter a layout number in Step S108, a maximum page count in Step S110, and a font size in Step S112. Then, in Step S114, the CPU 30 registers the user information entered in Steps S100 to S112 in the user profile table 300. Subsequently, the CPU 30 finishes the sequence of processes and returns to the original process.

Next, the content delivery process will be described in detail with reference to FIG. 9. FIG. 9 is a flowchart showing the content delivery process.

The content delivery process is the process of delivering digital content to the user terminal 200 with reference to the user profile table 300. It is performed by the CPU 30, beginning with Step S200 as shown in FIG. 9. Incidentally, the steps described below concerns only one record in the user profile table 300. Actually, however, each step is repeated as many times as there are records in the user profile table 300.

In Step S200, the CPU 30 reads out the delivery date and delivery time from the user profile table 300 and then goes to Step S202, where it judges based on the retrieved delivery date and delivery time whether now is the time to deliver the digital content. If now is the time (Yes), the CPU 30 goes to Step S204. Otherwise (No), the CPU 30 goes to Step S200.

In Step S204, the CPU 30 reads out the category number from the user profile table 300. In Step S206, it searches the content registration DB 44 and retrieves the digital content with the same category number, and then it goes to Step S208.

Then, the CPU 30 reads out the layout number from the user profile table 300 in Step S208, reads out the layout template corresponding to the retrieved layout number from the template registration DB 42 with reference to the layout template table 330 in Step S210, performs an automatic layout process based on the retrieved layout template in Step S212 to determine output layout of the digital content retrieved in Step S206 and create digital content for provision, and then goes to Step S214.

The CPU 30 reads out the delivery address from the user profile table 300 in Step S214 and delivers the created digital content for provision to the delivery address in Step S216. Then, the CPU 30 finishes the sequence of processes and returns to the original process.

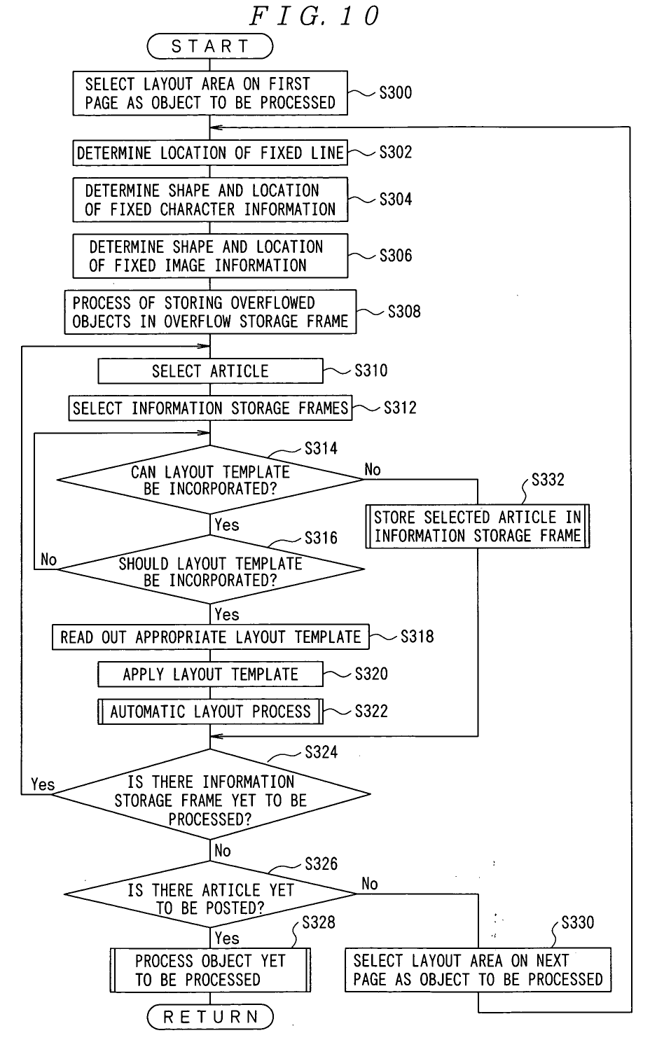

Next, the automatic layout process in Step S212 will be described in detail with reference to FIG. 10. FIG. 10 is a flowchart showing the automatic layout process.

The automatic layout process in Step S212 is performed beginning with Step S300 as shown in FIG. 10.

In Step S300, the CPU 30 selects the layout area 360 on the first page as an object to be processed from among the layout areas 360 prescribed by the layout template read out in Step S210. Then, the CPU 30 determines the location of a line to be fixed in the page in Step S302, determines the shape and location of character information to be fixed in the page in Step S304, determines the shape and location of image information to be fixed in the page in Step S306, and then goes to Step S308.

In Step S308, the CPU 30 determines the shape and location of an overflow storage frame and stores overflowed objects in the overflow storage frame. In Step S310, it selects an article to be placed in the layout area 360 from among the digital content retrieved in Step S206. In Step S312, the CPU 30 selects an information storage frame from the layout area 360 currently being processed (hereinafter referred to as the current layout area), and then it goes to Step S314.

In Step S314, the CPU 30 judges whether the information storage frame selected in Step S312 (hereinafter referred to as the selected information storage frame) sets up reference information, and thereby judges whether another layout template can be substituted for or incorporated into the information storage frame. If it is found that another layout template can be incorporated (Yes), the CPU 30 goes to Step S316.

In Step S316 the CPU 30 judges whether the article selected in Step S310 (hereinafter referred to as the selected article) sets up an incorporation indicator, and thereby judges whether a layout template should be incorporated. If it is found that a layout template should be incorporated (Yes), the CPU 30 goes to Step S318.

In Step S318, the CPU 30 reads out the layout template from the template registration DB 42 based on the reference information set up in the selected information storage frame. In Step S320, the CPU 30 regards the area identified by the size and placement location of the selected information storage frame as the layout area 360, places the information storage frame prescribed by the retrieved layout template in the area by contracting them. In Step S322, the CPU 30 stores the selected article in the placed information storage frame (if two or more information storage frames are placed, the selected article and related articles are stored in them), and then the CPU 30 goes to Step S324.

In Step S324, the CPU 30 judges whether there is an information storage frame yet to be processed in the layout area 360. If it is found that there is no information storage frame yet to be processed (No), the CPU 30 goes to Step S326, where it judges whether the digital content retrieved in Step S206 includes an article yet to be posted. If it is found that there is no article yet to be posted (No), the CPU 30 goes to Step S328, where it posts overflowed objects yet to be posted. Then, the CPU 30 finishes the sequence of processes and returns to the original process.

On the other hand, if it is found in Step S326 that there is an article yet to be posted (Yes), the CPU 30 goes to Step S330, where it selects the layout area 360 on the next page as an object to be processed from among the layout areas 360 prescribed of the layout template readout in Step S210. Then, the CPU 30 goes to Step S302.

On the other hand, if it is found in Step S324 that there is an information storage frame yet to be processed in the layout area 360 (Yes), the CPU 30 goes to Step S310.

On the other hand, if it is determined in Step S316 not to incorporate a layout template (No) or if it is found in Step S314 that another layout template cannot be incorporated (No), the CPU 30 goes to Step S332, where it stores the selected article in the selected information storage frame. Then, the CPU 30 goes to Step S324.

Next, operation of this embodiment will be described.

First, description will be given of a case in which information necessary for delivery of digital content is registered.

A user who wants digital content to be delivered accesses the content delivery terminal 100 using a WWW browser running on the user terminal 200 and enters a user registration request.

On the user terminal 200, as the user enters the user registration request, he/she is prompted via communications with the content delivery terminal 100 to enter necessary user information. When the user enters user information in response to the prompt, including a main category, subcategory, user ID, password, delivery address, delivery date, delivery time, layout number, maximum page count, and font size, the user information is sent to the content delivery terminal 100.

Upon receiving the user information following the registration request, the content delivery terminal 100 goes through Steps S100 to S114 to register the received user information in the user profile table 300.

Next, description will be given of a case in which digital content is delivered with reference to the user profile table 300.

With reference to the user profile table 300, the content delivery terminal 100 watches for the date and time when the digital content should be delivered. When the time comes, it goes through Steps S204 and S206 to read out the category number from the user profile table 300, search the content registration DB 44, and retrieve the digital content with the same category number. Then, the content delivery terminal 100 goes through Steps S208 to S212 to read out the layout number from the user profile table 300, read out the layout template corresponding to the retrieved layout number from the template registration DB 42 with reference to the layout template table 330, determine output layout of the retrieved digital content based on the retrieved layout template, and create digital content for provision.

In the process of layout, the content delivery terminal 100 goes through Steps S300 to S306 to select the layout area 360 on the first page as an object to be processed and determine the location of a fixed line, the shape and location of fixed character information, and shape and location of fixed image information in this order.

FIGS. 11A to 11E are diagrams illustrating the process of layout. As shown in FIG. 11A, the first page of the layout template read out in Step S210 lays out a specific information storage frame 600 on the top left side of the layout area 360, character information storage frame 602 on the top right side of the layout area 360, and image information storage frame 604 in the lower half of the layout area 360. The specific information storage frame 600 sets up reference information and can incorporate a layout template as shown in FIG. 11B. The layout template in FIG. 11B prescribes placement of an image information storage frame 606 on the top left side of the layout area 360 and placement of a character information storage frame 608 on the top right side and in the lower half of the layout area 360.

In this case, the content delivery terminal 100 goes through Steps S310 and S312 to select an article to be placed in the layout area 360 from the digital content retrieved in Step S206 and select information storage frames from the current layout area 360. If the selected article sets up an incorporation indicator and a specific information storage frame 600 is selected, the content delivery terminal 100 goes through Steps S318 to S322 to read out the layout template shown in FIG. 11B from the template registration DB 42 based on the reference information set up in the specific information storage frame 600. Then, as shown in FIG. 11C, the content delivery terminal 100 regards the area identified by the size and placement location of the specific information storage frame 600 as the layout area 360, places the information storage frames 606 and 608 prescribed by the retrieved layout template in the area by contracting them, and stores the selected article and a related article in the placed information storage frames 606 and 608. On the other hand, even if a specific information storage frame 600 is selected, if the selected article is not setting up an incorporation indicator, delivery terminal 100 goes through Step S332 to store the selected article directly in the specific information storage frame 600.

Also, for example, a layout template such as the one shown in FIG. 11D can be incorporated into the specific information storage frame 600 instead of the layout template shown in FIG. 11B. The layout template in FIG. 11D prescribes placement of an information storage frame 610 almost over the entire area of the layout area 360.

In this case, the content delivery terminal 100 goes through Steps S310 and S312 to select an article to be placed in the layout area 360 from the digital content retrieved in Step S206 and select information storage frames from the current layout area 360. If the selected article sets up an incorporation indicator and a specific information storage frame 600 is selected, the content delivery terminal 100 goes through Steps S318 to S322 to read out the layout template shown in FIG. 11D from the template registration DB 42 based on the reference information set up in the specific information storage frame 600. Then, as shown in FIG. 11E, the content delivery terminal 100 regards the area identified by the size and placement location of the specific information storage frame 600 as the layout area 360, places the image information storage frame 610 prescribed by the retrieved layout template in the area by contracting it, and stores the selected article in the placed image information storage frame 610. On the other hand, even if a specific information storage frame 600 is selected, if the selected article is not setting an incorporation indicator, the content delivery terminal 100 goes through Step S332 to store the selected article directly in the specific information storage frame 600.

If there is no more information storage frame yet to be processed, the content delivery terminal 100 goes through Steps S324, S326, and S330 to select the layout area 360 on the next page as an object to be processed and repeat the storage process described above.

The storage process is repeated until there is no more article yet to be posted in the digital content retrieved in Step S206. Consequently, all the articles contained in the retrieved digital content are posted and the output layout of the digital content is determined. Once the output layout is determined, the content delivery terminal 100 goes through Steps S212 and S214 to read out the delivery address from the user profile table 300 and deliver the created digital content for provision to the delivery address read out.

In this way, according to this embodiment, when laying out a specific information storage frame, the content delivery terminal 100 reads out a layout template from the template registration DB 42 based on reference information, regards the area identified by the size and placement location of the specific information storage frame as the layout area 360, places the information storage frame prescribed by the retrieved layout template in the area by contracting it, and stores an article in the placed information storage frame.

Consequently, the entire layout is performed according to the layout template. Regarding a specific information storage frame, its area is laid out according to the layout template set up for the information storage frame. Thus, once the designer prepares a desired layout template, an almost intended layout can be produced whether in part or as a whole. This makes it possible to reduce the possibility of deviating from the layout intended by the designer regardless of the contents, volume, and logical structure of the information to be posted. Also, if layout templates are referred to partially, a great variety of layouts can be produced by simply combining the layout templates without the need to create a large number of layout templates. Thus, a large number of layouts desired by the designer can be created relatively easily.

Furthermore, according to this embodiment, if a selected article sets up an incorporation indicator, the content delivery terminal 100 reads out a layout template from the template registration DB 42 based on reference information and makes the retrieved layout template substituted for or incorporated into the specific information storage frame.

Consequently, if it is determined to incorporate the layout template based on the contents, volume, or logical structure of the article, the area of the specific information storage frame is laid out based on the layout template, but if it is determined not to incorporate the layout template based on the contents, volume, or logical structure of the posting information, the article is stored directly in the specific information storage frame. Thus, layout can be performed relatively appropriately based on the contents, volume, or logical structure of the posting information. Also, since an article can set up an incorporation indicator, incorporation of the layout template can be instructed relatively easily. In particular, this is suited for instructing a layout template to be incorporated depending on the contents, volume, or logical structure of an article.

Furthermore, according to this embodiment, the content delivery terminal 100 retrieves digital content from the content registration DB 44 based on the user information in the user information registration DB 40.

Consequently, since information unique to the user or information specified by the user is referred to when selecting digital content, it is possible to create digital content for provision relatively in line with the user's wishes.

Furthermore, according to this embodiment, the content delivery terminal 100 determines the output layout of digital content and creates digital content for provision based on the user information in the user information registration DB 40.

Consequently, since information unique to the user or information specified by the user is referred to when determining output layout, it is possible to create digital content for provision with an output layout relatively in line with the user's wishes.

In the above embodiment, the user information registration DB 40 corresponds to the user information storage section according to embodiment 16, 17, 33, 34, 50, or 51; the template registration DB 42 corresponds to the template storage section according to embodiment 1, 2, 4, 5, 18, 19, 21, 22, 35, 36, 38, or 39; and the content registration DB 44 corresponds to the posting-information storage section according to embodiment 2, 16, 19, 33, 36, or 50. Also, Step S206 corresponds to the posting-information selection section according to embodiment 2, 16, 17, 19, 33, 34, 50, or 51; Step S212 corresponds to the layout section according to any of embodiments 1 to 5, 9, 17, and 18 to 22, or the layout step according to any of embodiments 35 to 39; and the article corresponds to the posting information according to embodiment 1, 2, 4, 5, 9, 16, 17, 18, 19, 21, 22, 26, 33, 34, 35, 36, 38, 39, 43, 50, or 51.

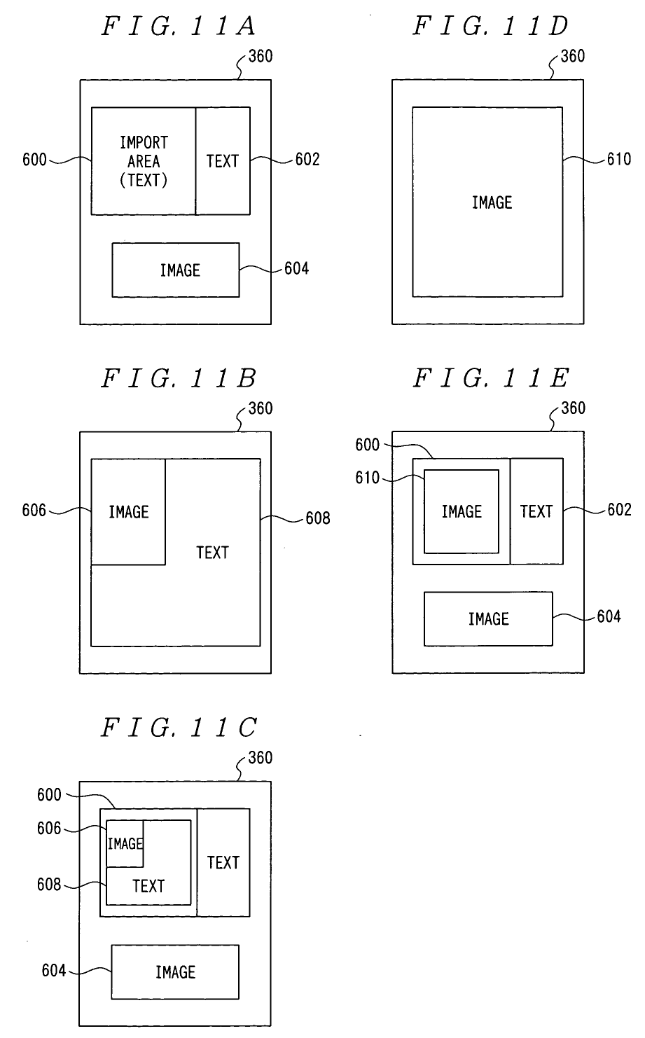

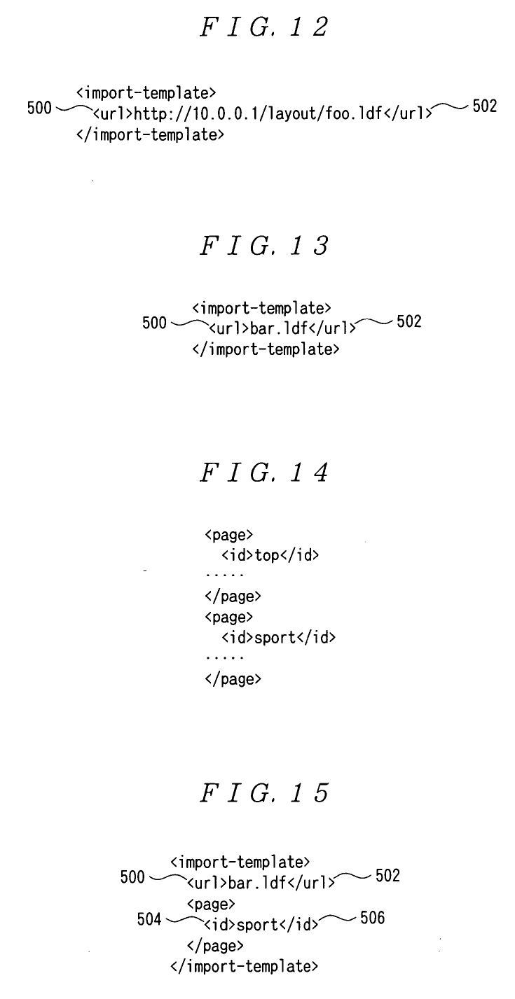

Incidentally, although in the above embodiment, the layout number is used as reference information, this is not restrictive. A URL (Uniform Resource Locator) may be used as reference information if a layout template is acquired from another server or the like on the Internet 199 as shown in FIGS. 12 and 13, which are diagrams showing data structure of a layout template which prescribes a specific information storage frame.

For example, to refer to a “foo.ldf” layout template in a “layout” layer on an HTTP (HyperText Transfer Protocol) server identified by an IP address “10.0.0.1,” reference information is provided, being sandwiched by a tag set consisting of a start tag and end tag in a description which starts with a predetermined start tag (e.g., <import-template>) and ends with a predetermined end tag (e.g., </import-template>) as shown in FIG. 12. In the example of FIG. 12, “http://10.0.0.1/layout/foo.ldf” is described by tag sets 500, 502 for setting reference information.

Also, for example, to refer to a “bar.ldf” layout template in the same layer as a layout template which prescribes a specific information storage frame, reference information is provided, being sandwiched by a tag set consisting of a start tag and end tag in a description which starts with a predetermined start tag (e.g., <import-template>) and ends with a predetermined end tag (e.g., </import-template>) as shown in FIG. 13. In the example of FIG. 13, “bar.ldf” is enclosed by a tag set (consisting of 500 and 502) which indicates reference information.

Also, although in the above embodiment, the layout template incorporated into a specific information storage frame prescribes layout for one page, this is not restrictive. It is also possible to use a layout template which prescribes layout for two or more pages. In that case, a unique ID is assigned to each page and used as reference information as shown in FIGS. 14 and 15. FIG. 14 is a diagram showing data structure of a layout template incorporated into a specific information storage frame while FIG. 15 is a diagram showing data structure of a layout template which prescribes the specific information storage frame.

FIG. 14 shows an example in which an ID “top”is assigned to the first page and an ID “sport” is assigned to the second page in relation to a layout template “bar.ldf” which prescribes layout for two pages. To incorporate the second page layout of the “bar.ldf” layout template, reference information and the ID are provided, each being sandwiched by a tag set consisting of a start tag and end tag in a description which starts with a predetermined start tag (e.g., <import-template>) and ends with a predetermined end tag (e.g., </import-template>) as shown in FIG. 15. In the example of FIG. 15, “bar.ldf” is enclosed by a tag set (consisting of 500 and 502) which indicates reference information and “sport” is enclosed by a tag set (consisting of 504 and 506) which indicates an ID.

Also, in the above embodiment, the area identified by the size and placement location of the specific information storage frame is regarded as the layout area 360 and the image information storage frame prescribed by the retrieved layout template is placed in the area by contracting it, but when a character information storage frame is placed, it is preferable to change the shape of the character information storage frame by limiting the variable range of character size.

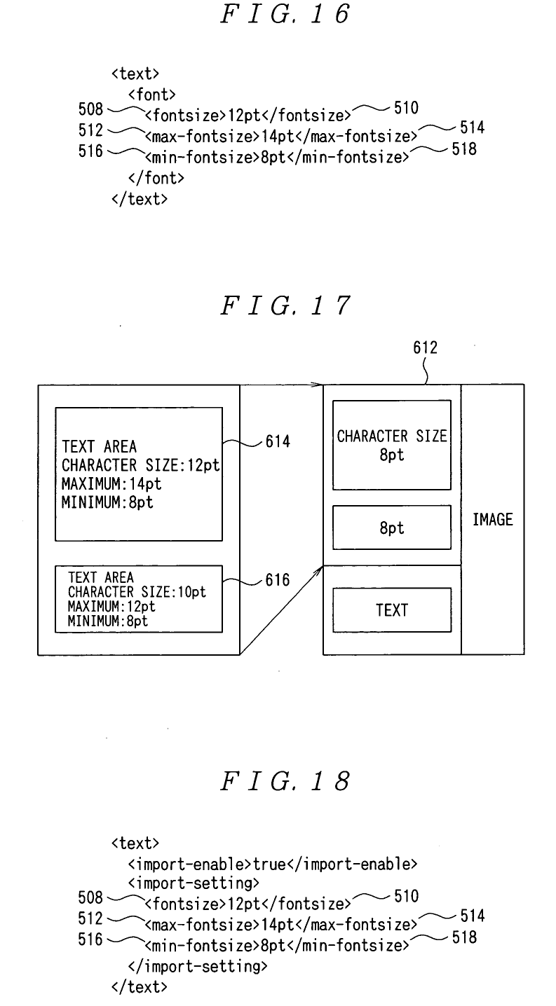

FIG. 16 is a diagram showing data structure of a layout template in which a lower font limit and upper font limit are specified. A layout template incorporated into a specific information storage frame specifies a lower font limit and upper font limit using tag sets each consisting of a start tag and end tag in a description which starts with a predetermined start tag (e.g., <font>) and ends with a predetermined end tag (e.g., </font>) as shown in FIG. 16. In the example of FIG. 16, “12pt” is enclosed by a tag set (consisting of 508 and 510) which indicates standard character size, “14pt” is enclosed by a tag set (consisting of 512 and 514) which indicates an upper font limit, and “8pt” is enclosed by a tag set (consisting of 516 and 518) which indicates a lower font limit. This means that when the layout template is used as an ordinary layout template, the font size is set to 12 points and that when the layout template is incorporated into a specific information storage frame, the character size is varied between 8 and 14 points.

Specifically, layout is performed as shown in FIG. 17, which is a diagram illustrating a process of layout performed with a lower font limit and upper font limit specified. As shown in FIG. 17, in an automatic layout process, when storing articles, which are character information, in character information storage frames 614 and 616 placed in the area identified by the size and placement location of a specific information storage frame 612, if a lower font limit has been specified for the character information storage frames 614 and 616, the layout system changes the shape of the character information storage frames 614 and 616 by changing character size in the character information storage frames 614 and 616 so that it will not fall below the lower font limit. Also, when storing articles, which are character information, in character information storage frames 614 and 616 placed in the area identified by the size and placement location of a specific information storage frame 612, if an upper font limit has been specified for the character information storage frames 614 and 616, the layout system changes the shape of the character information storage frames 614 and 616 by changing character size in the character information storage frames 614 and 616 so that it will not exceed the upper font limit.

This makes it possible to reduce the possibility of deviating from the layout intended by the designer in terms of character size.

In this case, Step S212 corresponds to the layout section according to embodiment 13, 14, 30, or 31 or layout step according to embodiment 47 or 48; and the article corresponds to the posting information according to embodiment 13, 14, 30, 31, 47, or 48.

Incidentally, although in the example of FIG. 16, the lower font limit and upper font limit are specified in a layout template incorporated into a specific information storage frame, this is not restrictive. It is also possible to specify the lower font limit and upper font limit in a layout template which prescribes the specific information storage frame as shown in FIG. 18.

FIG. 18 is a diagram showing data structure of a layout template in which a lower font limit and upper font limit are specified. As shown in FIG. 18, a layout template which prescribes a specific information storage frame specifies a lower font limit and upper font limit using tag sets each consisting of a start tag and end tag in a description which starts with a predetermined start tag (e.g., <import-setting>) and ends with a predetermined end tag (e.g., </import-setting>) as shown in FIG. 18. In the example of FIG. 18, “12pt” is enclosed by a tag set (consisting of 508 and 510) which indicates standard character size, “14pt” is enclosed by a tag set (consisting of 512 and 514) which indicates an upper font limit, and “8pt” is enclosed by a tag set (consisting of 516 and 518) which indicates a lower font limit. This means that when an article is stored in a regular manner, the font size is set to 12 points and that when the layout template is incorporated, the character size is varied between 8 and 14 points.

Also, although in the example of FIGS. 16 and 18, the lower font limit and upper font limit are specified in a layout template, this is not restrictive. It is also possible to specify the lower font limit and upper font limit in an article.

Also, in the above embodiment, the area identified by the size and placement location of the specific information storage frame is regarded as the layout area 360 and the image information storage frame prescribed by the retrieved layout template is placed in the area by contracting it, but when an image information storage frame is placed, it is preferable to contract the image information storage frame while maintaining the aspect ratio of the layout area.

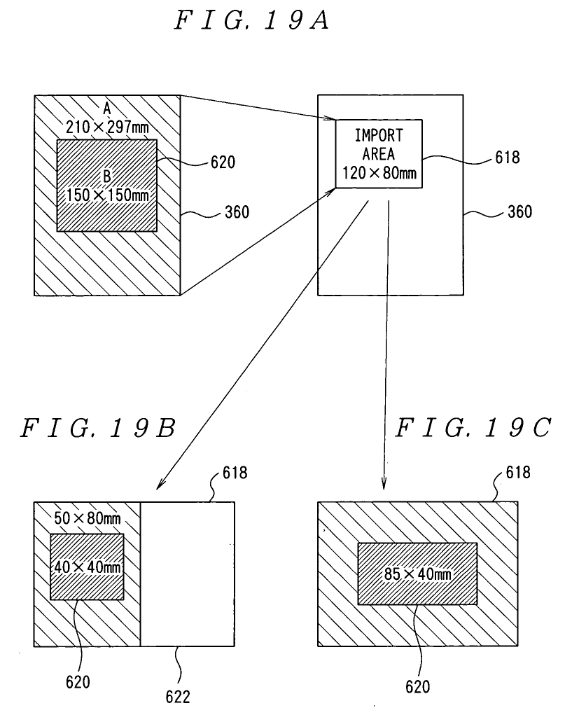

FIGS. 19A to 19C are diagrams illustrating a process of layout performed when a layout template which prescribes an image information storage frame is incorporated. In the example of FIG. 19A, a layout template which prescribes an image information storage frame 620 is incorporated into a specific information storage frame 618, the layout area 360 which contains the image information storage frame 620 has portrait orientation (210 mm horizontally×297 mm vertically) while the specific information storage frame 618 has landscape orientation (120 mm horizontally×80 mm vertically). In this case, changing the aspect ratio of the layout area 360 which contains the image information storage frame 620 will make the image in the image information storage frame 620 long in horizontal direction and may impair the layout. Thus, as shown in FIG. 19B, the layout template is incorporated into the specific information storage frame 618 while maintaining the aspect ratio of the layout area 360 which contains the image information storage frame 620.

This prevents the image from being long in horizontal direction, and thus further reduces the possibility of impairing the layout.

In this case, Step S212 corresponds to the layout section according to embodiment 15 or 32 or layout step according to embodiment 49.

In contrast, maintaining the aspect ratio of the layout area 360 which contains the image information storage frame 620 will cause a blank space 622 to be produced in the specific information storage frame 618 as shown in FIG. 19B. Thus, to prevent the blank space 622 from being produced, either the aspect ratio of the layout area 360 which contains the image information storage frame 620 is changed as shown in FIG. 19C or another information storage frame or article is placed in the blank space 622 while maintaining the aspect ratio. The latter approach can avoid the possibility of impairing the layout as well as prevent the blank space 622 from being produced.

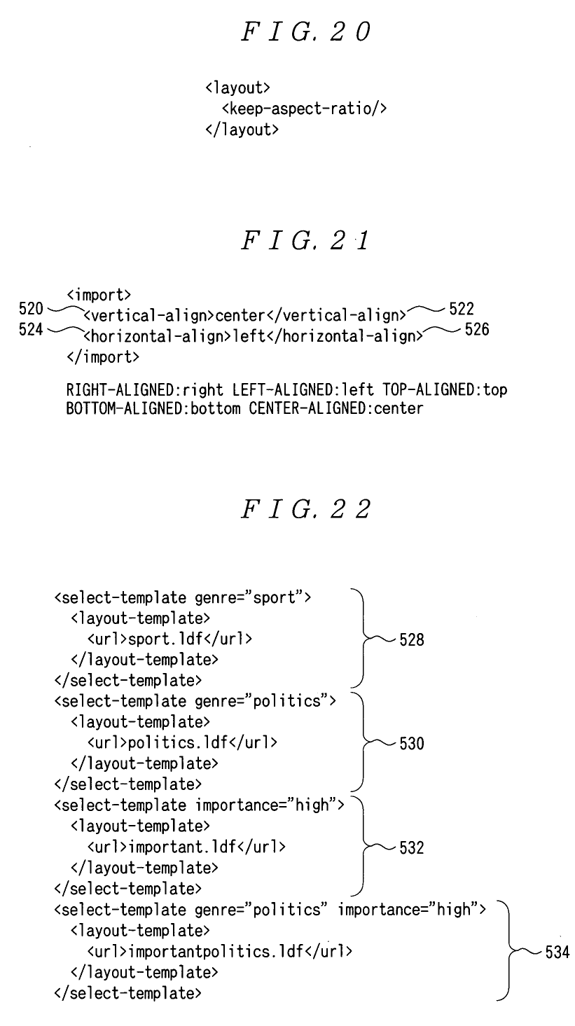

To maintain the aspect ratio, the layout template describes “<keep-aspect-ratio/>” between a predetermined start tag (e.g., <layout>) and a predetermined end tag (e.g., </layout>) as shown in FIG. 20, which is a diagram showing data structure of a layout template incorporated into a specific information storage frame.

In the example of FIG. 19B, the layout area 360 which contains the image information storage frame 620 is left-aligned horizontally and the layout template specifies horizontal and vertical alignment using tag sets each consisting of a start tag and end tag in a description which starts with a predetermined start tag (e.g., <import>) and ends with a predetermined end tag (e.g., </import>) as shown in FIG. 21, which is a diagram showing data structure of a layout template which prescribes a specific information storage frame. In the example of FIG. 21, “center” is sandwiched by a tag set (consisting of 520 and 522) which indicates vertical alignment and “left” is sandwiched by a tag set (consisting of 524 and 526) which indicates horizontal alignment. This means that the object placed in the layout area 360 is center-aligned vertically and left-aligned horizontally.

Also, although in the above embodiment, only one layout template is set up for a specific information storage frame, this is not restrictive and two or more layout templates may be set up. In that case, it is conceivable to incorporate layout templates selectively according to the importance or category of articles. FIG. 22 is a diagram showing data structure of a plurality of layout templates which are incorporated selectively.

In the example of FIG. 22, a layout template “sport.ldf” for sports articles, layout template “politic.ldf” for political articles, layout template “important.ldf” for important articles (general), and layout template “importantpolitic.ldf” for important political articles are prepared first. Then, a group of tag sets 528 prescribes that the layout template “sport.ldf” should be incorporated if the category of an article is sports and a group of tag sets 530 prescribes that the layout template “politic.ldf” should be incorporated if the category of an article is politics. Also, a group of tag sets 532 prescribes that the layout template “important.ldf” should be incorporated if an article has a high importance and a group of tag sets 534 prescribes that the layout template “importantpolitic.ldf” should be incorporated if an article has a high importance and belongs to the category of politics. Incidentally, the use of the groups of tag sets 528 to 534 is based on the examples in FIGS. 12 to 16, 18, and 21.

Also, although in the above embodiment, an incorporation indicator is set up in an article, this is not restrictive and an incorporation indicator may be set up in a layout template. When a layout template sets up an incorporation indicator, it is read out of the template registration DB 42 based on reference information and the retrieved layout template is substituted for or incorporated into a specific information storage frame.

Since an incorporation indicator can be set up in a layout template, incorporation of the layout template can be instructed relatively easily.

In this case, the template registration DB 42 corresponds to the template storage section according to embodiment 6, 23, or 40; and Step S212 corresponds to the layout section according to embodiment 6 or 23 or layout step according to embodiment 40.

Also, although in the above embodiment, an incorporation indicator is set up in an article, this is not restrictive and an incorporation indicator may be given as an argument. When an incorporation indicator is given as an argument, a layout template is read out of the template registration DB 42 based on reference information and the retrieved layout template is substituted for or incorporated into a specific information storage frame.

Since an incorporation indicator can be given as an argument, incorporation of the layout template can be instructed relatively easily.

In this case, the template registration DB 42 corresponds to the template storage section according to embodiment 7, 24 or 41; and Step S212 corresponds to the layout section according to embodiment 7 or 24 or layout step according to embodiment 41.

Also, although in the above embodiment, an incorporation indicator is set up only in an article, this is not restrictive. An incorporation indicator may be set up in a page template and article and given as an argument. Thus, multiple settings can be made using a page template, article, and argument. However, they may conflict with each other. In that case, priorities can be assigned to the page-template-based setting, article-based setting, and argument-based setting. Then, if different settings are made, one of them can be adopted according to the priorities.

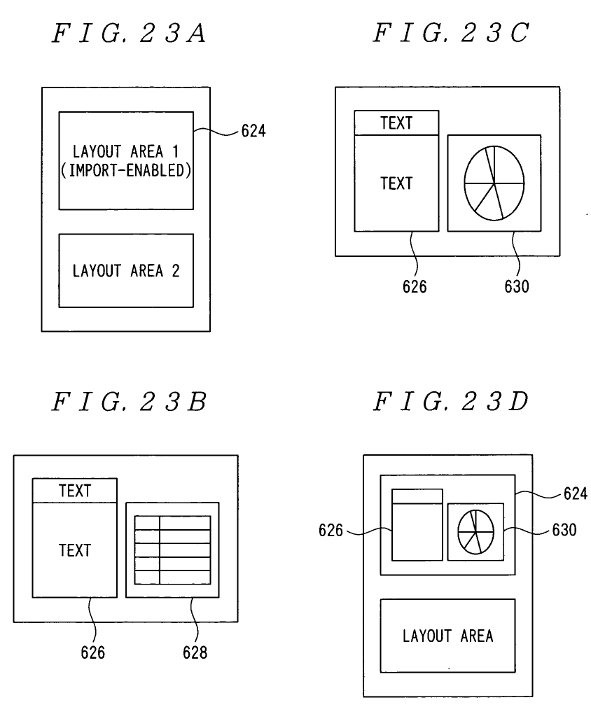

FIGS. 23A to 23D are diagrams illustrating a process of layout performed when priorities are assigned to multiple settings. FIG. 23A shows how a layout template is incorporated into a specific information storage frame 624 when the first priority is assigned to the layout template in FIG. 23B and the second priority is assigned to the layout template in FIG. 23C. The layout template in FIG. 23B contains a character information storage frame 626 and a table storage frame 628 for storing a table while the layout template in FIG. 23C contains a character information storage frame 626 and a graph storage frame 630 for storing a graph.

Normally, in this case, the layout template in FIG. 23B is incorporated into the selected article, which is then stored in the character information storage frame 626 and table storage frame 628. Only if this layout template does not work properly, the layout template in FIG. 23C is incorporated into the selected article, which is then stored in the character information storage frame 626 and graph storage frame 630. However, if priorities have been assigned such that the setting in an article takes precedence over the setting in a layout template, when an article setting up an incorporation indicator which instructs the layout template in FIG. 23C to be incorporated is selected, the layout template in FIG. 23C is incorporated, as shown in FIG. 23D, into the selected article, which is then stored in the character information storage frame 626 and graph storage frame 630. Only if this layout template does not work properly, the layout template in FIG. 23B is incorporated into the selected article, which is then stored in the character information storage frame 626 and table storage frame 628.

Since an incorporation indicator can be set up in the layout template or the posting information or given as an argument, incorporation of the layout template can be instructed relatively easily. Also, even if multiple settings made using a layout template, article, and argument conflict with each other, one of them can be adopted according to the priorities. This further reduces the possibility of impairing the layout.

In this case, the template registration DB 42 corresponds to the template storage section according to embodiment 8, 25 or 42; Step S212 corresponds to the layout section according to embodiment 8 or 25 or layout step according to embodiment 42; and the article corresponds to the posting information according to embodiment 8, 25, or 42.

Although size change of a specific information storage frame has not been described in particular in the above embodiment, the present invention may be configured such that the size of a specific information storage frame will be change depending on the layout template to be incorporated.

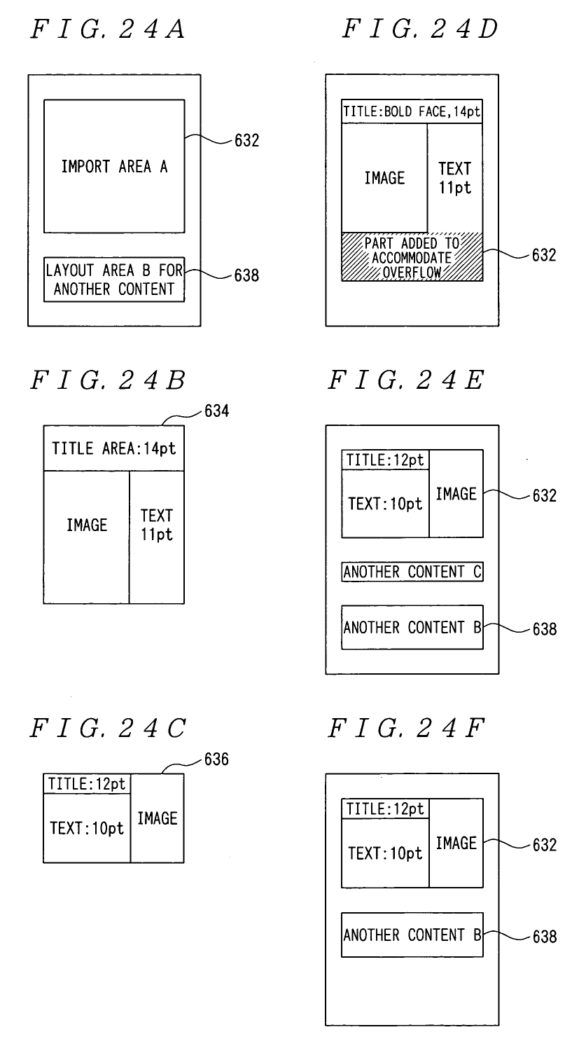

FIGS. 24A to 24F are diagrams illustrating a process of layout performed when the size of a specific information storage frame is changed. FIG. 24A shows how the layout template in FIG. 24B or the layout template in FIG. 24C is incorporated into a specific information storage frame 632. The layout template in FIG. 24B has a compound information storage frame (a set of a title information storage frame, image information storage frame, and character information storage frame) 634 which is horizontally as long as, and vertically longer than, the specific information storage frame 632. The layout template in FIG. 24C has a compound information storage frame 636 which is horizontally as long as, and vertically shorter than, the specific information storage frame 632.

To incorporate the layout template in FIG. 24B, since the compound information storage frame 634 is horizontally as long as, and vertically longer than, the specific information storage frame 632, the bottom side of the specific information storage frame 632 is expanded downward as shown in FIG. 24D and the compound information storage frame 634 is placed in the expanded specific information storage frame 632. Another information storage frame 638 overlaps with the specific information storage frame 632 as a result of the expansion, and it is either deleted or moved to the layout area 360 of another page.

Next, to incorporate the layout template in FIG. 24C, since the compound information storage frame 636 is horizontally as long as, and vertically shorter than, the specific information storage frame 632, the bottom side of the specific information storage frame 632 is slid upward, thereby contracting the specific information storage frame 632 as shown in FIGS. 24E and 24F and the compound information storage frame 636 is placed in the contracted specific information storage frame 632. A blank space is produced as a result of the contraction, and either another information storage frame or article is placed in it as shown in FIG. 24E or it is filled by another information storage frame 638 moved upward as shown in FIG. 24F.

Also, in the above embodiment, a layout template is read out from the template registration DB 42 based on reference information, the area identified by the size and placement location of the specific information storage frame is regarded as the layout area 360, the information storage frame prescribed by the retrieved layout template is contracted and placed in the area, and an article is stored in the placed information storage frame. However, this is not restrictive, and it is also possible to perform layout by storing the article in the image information storage frame prescribed by the retrieved layout template, regard the area identified by the size and placement location of the specific information storage frame as the layout area 360, and contract the layout results to fit in the area.

In this case, Step S212 corresponds to the layout section according to embodiment 10 or 27 or layout step according to embodiment 44; and the article corresponds to the posting information according to embodiment 10, 27, or 44.

Also, in the above embodiment, a layout template is read out from the template registration DB 42 based on reference information, the area identified by the size and placement location of the specific information storage frame is regarded as the layout area 360, the information storage frame prescribed by the retrieved layout template is contracted and placed in the area, and an article is stored in the placed information storage frame. However, this is not restrictive, and the layout system may be provided with capabilities to store an article both before and after placing the information storage frame and configured to use one of the two sequences selectively according to processing priority. Specifically, processing priority can be set to indicate which should be done first, the placement of the information storage frame or the storage of the posting information. Then, if it is determined to place the information storage frame first based on the processing priority, the area identified by the size and placement location of the information storage frame is regarded as the layout area 360, the information storage frame prescribed by the retrieved layout template is placed in the area by contracting it, and layout is performed by storing the posting information in the placed information storage frame. On the other hand, if it is determined to store the posting information first based on the processing priority, layout is performed by storing the posting information in the information storage frame prescribed by the retrieved layout template, the area identified by the size and placement location of the information storage frame is regarded as the layout area 360, and layout results are contracted to fit in the area.

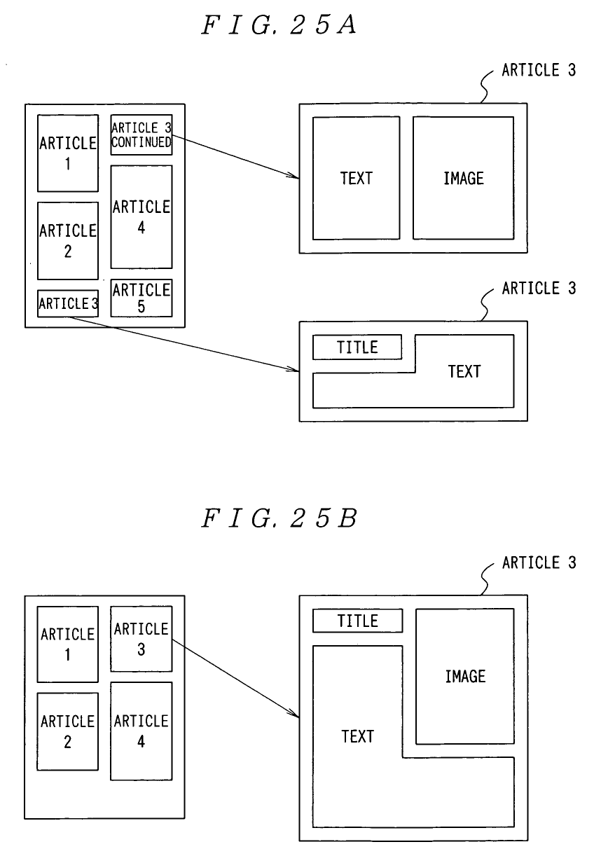

Layout results may differ between the case where an article is stored after placing an information storage frame and the case where the same article is stored before placing the information storage frame. For example, if an article is stored after an information storage frame is placed as shown in FIG. 25A, the article 3 is laid out extending over two columns, but if the article is stored before the information storage frame is placed, as shown in FIG. 25B, the article 3 is laid out without extending over two columns. FIGS. 25A and 25B are diagrams illustrating layout processes which differ in the order of placement and storage. Thus, by specifying processing priority, it is possible to select the sequence which will result in an appropriate layout.

In this case, Step S212 corresponds to the layout section according to embodiment 11 or 28; and the article corresponds to the posting information according to embodiment 11, 28, or 45.

Also, although in the above embodiment, no description has been given of a case in which the layout template to be incorporated does not exist in the template registration DB 42, the present embodiment can be configured to read out a substitute layout template from the template registration DB 42 if the appropriate template does not exist in the template registration DB 42 for some reason. This is particularly useful when acquiring a layout template from another server or the like on the Internet 199.

Consequently, if an appropriate layout template does not exist in the template registration DB 42 for some reason, a substitute layout template is read out, reducing the possibility of impairing the layout.

In this case, the template registration DB 42 corresponds to the template storage section according to embodiment 12, 29 or 46; and Step S212 corresponds to the layout section according to embodiment 12 or 29.

Also, although in the above embodiment, a layout number, URL, ID, etc. are used as reference information set up in an information storage frame, this is not restrictive and a word which indicates effect of layout (hereinafter referred to as an impression word) may be used as reference information.

In that case, an impression word which indicates intended effect of layout (e.g., “impact, ” “vitality,” etc.) has been described in each layout template in the template registration DB 42 in addition to information such as the type and quantity of the content to be laid out.

Then, for example, the user is prompted to enter or otherwise specify a desired impression word for the information storage frame instead of a layout number. Consequently, when laying out content in the information storage frame into which a template is allowed to be incorporated, the system reads out an appropriate template from the template registration DB 42 based on the impression word specified by the user as well as on information about the content to be laid out. This configuration allows the system to search the template registration DB 42 for a template which matches the quantity and type of content as well as the impression word specified by the user and substitute the layout area with the retrieved layout template.

An example of a layout process which uses an impression word will be described below.

First, an impression word is entered in the user registration process in Steps S100 to S114. For example, an impression word is entered after the layout number of an underlying template is entered in Step S108. According to this embodiment, it is assumed that no impression word has been associated with the underlying template.

Next, when the process in Steps S204 to S216 is started on the delivery date and time registered in the user information registration DB 40, the layout number is read out from the user information registration DB 40 in Step S208. Then, in Step S210, the template corresponding to the layout number is read out from the template registration DB 42, the impression word is read out from the user information registration DB 40, and the impression word is specified for the information storage frame of the retrieved template. Then, an automatic layout process is performed in Step S212 based on the layout template in which the impression word is set.

Furthermore, if it is found in Step S314 of the automatic layout process that another layout template can be incorporated and it is determined in Step S316 to incorporate a layout template, a template which corresponds to the impression word specified for the information storage frame is read out from the template registration DB 42 in Step S318, the retrieved template is applied in Step S320, and the automatic layout process is performed in Step S322.

Thus, by simply specifying a desired impression word, the user can obtain content laid out based on a layout template which corresponds to the impression word.

Incidentally, it has been explained above that the automatic layout process is performed by reading out a template which corresponds to the impression word. The template which corresponds to the impression word may be not only a template which matches the registered impression word, but also a template associated with an impression word similar to the registered impression word.

Also, it has been explained above that the user enters a desired impression word, but it is not restrictive. For example, a phrase contained in the content associated with a category number registered in the user information registration DB 40 may be registered as an impression word in an information storage frame, and then a template corresponding to the impression word may be read out and used for the automatic layout process.

Also, in the above embodiment, a layout template is incorporated into or substituted for a partially selected layout area of another layout template, and thereby an overall layout is performed using a combination of layout templates designed by the designer. However, when substituting a partially selected layout area with another layout template, it is also possible to replace only the font for text in the appropriate area while keeping the size, shape, etc of the area as they are instead of partially changing the layout of the area.

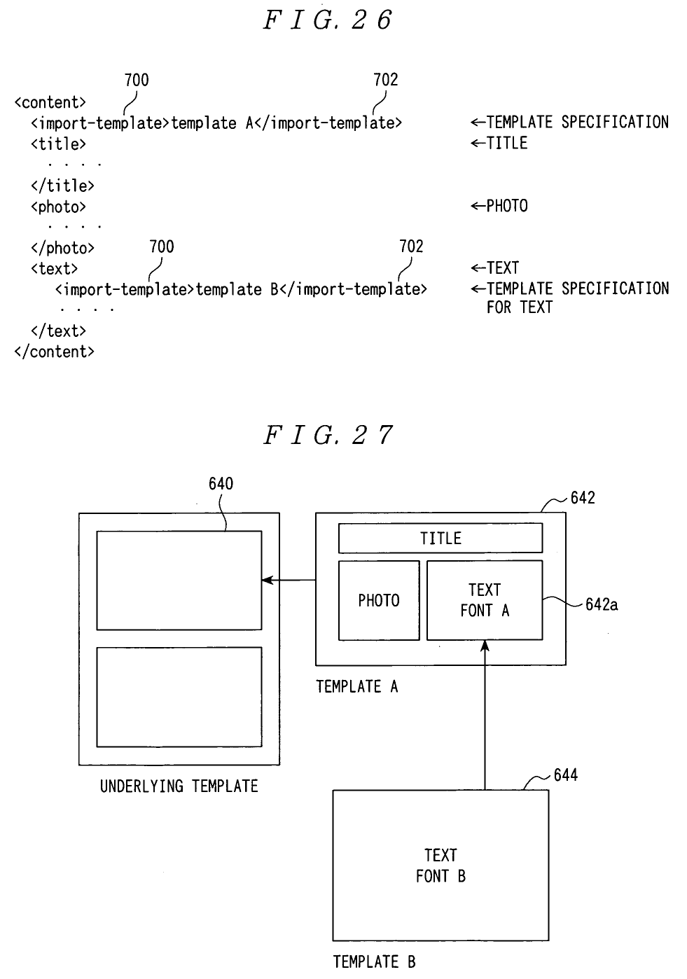

A layout process in which a font change can be made through template replacement will be described below with reference to FIGS. 26 and 27. FIG. 26 is a diagram showing data structure of content part in which a template for font replacement is set up while FIG. 27 is a diagram illustrating a process of layout performed when the template for font replacement is set up.

In the example of FIG. 26, a title, images (photos in the case of FIG. 26), text, etc. to be laid out are described between “<content>” and “</content>”. Furthermore, a tag set (consisting of 700 and 702) describes that a template to be substituted for an import area 640 (FIG. 27) will be designated as “template A642.” Also, a tag set (consisting of 700 and 702) describes that in the layout template A642, a text layout frame 642a in which text is laid out using font A will be substituted with a “template B644” which lays out the text using font B.

Thus, in the layout process, the import area 640 will be substituted with the layout template A642 read out of the template registration DB 42 while the text layout frame 642a in the layout template A642 will be substituted with the layout template B644 read out of the template registration DB 42, as shown in FIG. 27.

Thus, the text layout frame 642a in which text is laid out using a predetermined font (font A in the example of FIG. 27) can be substituted easily with a template which lays out the text using a different font (font B in the example of FIG. 27).

Also, although in the above embodiment, an incorporation indicator is included in an article apart from a category number, this is not restrictive and a specific category number may be included in an article as the incorporation indicator. The same applies when using an article number, a main category, a subcategory, or other additional information as a substitute for the incorporation indicator.

Also, although in the above embodiment, character information and image information are used as article information, this is not restrictive and other multimedia information such as animation information and audio information may be used as article information.

Also, although in the above embodiment, layout is performed by dynamically determining the shapes and locations of information storage frames, this is not restrictive and it is also possible to store information once in all the information storage frames in the layout area 360 and then perform layout by determining their shapes and locations.

Also, although in the above embodiment, the output layout of digital content is determined based on user information, this is not restrictive and it is also possible to determine the output layout of the digital content based on the number of images or volume of character information contained in the digital content.

This will make it possible to produce a relatively easy-to-view output layout even if digital content contains a rather large or small quantities of images or character information.

Also, although in the above embodiment, the layout process in Step S212 is performed on the content delivery terminal 100, this is not restrictive and the process may be performed on the user terminal 200. This will prevent concentration of processing load on the content delivery terminal 100.

Also, although in the above embodiment, the processes in the flowcharts of FIGS. 8 to 10 are performed through execution of the control program stored in the ROM 32, this is not restrictive and it is also possible to load a program for the procedures from a storage medium into the RAM 34 for execution.

The storage medium here may be of any type, provided it is computer-readable, regardless of whether it is electronic, magnetic, or optical: it maybe a semiconductor storage medium such as a RAM or ROM; magnetic storage medium such as an FD or HD; optical storage medium such as a CD, CDV, LD, or DVD; or magneto-optical storage medium such as an MO.

Also, although in the above embodiment, the layout system, layout program, and layout method according to the present invention are applied to a network system, namely, the Internet 199, this is not restrictive and it is also possible to apply them to so-called intranets which conduct communications by the same method as the Internet 199. Of course, they may also be applied to ordinary networks in addition to the networks which conduct communications by the same method as the Internet 199.

Also, although in the above embodiment, the layout system, layout program, and layout method according to the present invention are applied to a case in which a content delivery terminal 100 delivers digital content such as news to a user terminal 200 as shown in FIG. 1, this is not restrictive and they may also be applied to other cases without departing from the spirit and scope of the present invention.

What is claimed is:

1. A layout system comprising:
layout section for laying out posting information, the layout section performing layout by storing the posting information in information storage frames laid out in a predetermined layout area, according to a layout template which prescribes matters concerning the information storage frames for the layout area; and
template storage section for storing the layout template,
wherein the layout template is set up for use instead of the information storage frames or for incorporation into the information storage frames,
the layout section reads the layout template in connection with the set up out of the template storage section and makes the retrieved layout template substituted for or incorporated into the information storage frames for which the layout template has been set up.

2. A layout system comprising:
posting-information storage section for storing multiple pieces of posting information;
template storage section for storing layout templates which prescribe, for a predetermined layout area, matters concerning information storage frames to be placed in the layout area;
posting-information selection section for selecting posting information from the multiple posting information stored in the posting-information storage section; and
layout section for laying out the posting information selected by the posting-information selection section, the layout section performing layout by storing the posting information in the information storage frames according to a layout template stored in the template storage section, wherein:
the information storage frames set up reference information for referring to the layout template, and
when laying out the information storage frame setting up the reference information, the layout section reads out the layout template from the template storage section based on the reference information and makes the retrieved layout template substituted for or incorporated into the information storage frame setting up the reference information.

3. The layout system according to claim 2, wherein:
the layout template prescribes the sizes and placement locations of the information storage frames; and
the layout section regards an area identified by the size and placement location of the information storage frame containing the reference information as the layout area and places the information storage frames prescribed by the retrieved layout template in the area by expanding or contracting the information storage frames.

4. The layout system according to claim 3, wherein:
the layout section determines whether to incorporate the layout template into the information storage frame setting up the reference information based on contents, volume, or logical structure of the posting information and if the layout section determines to incorporate the layout template, the layout section reads out the layout template from the template storage section based on the reference information and makes the retrieved layout template substituted for or incorporated into the information storage frame setting up the reference information.

5. The layout system according to claim 4, wherein:
the posting information contains an incorporation indicator which instructs the layout template to be incorporated; and
when the posting information sets up the incorporation indicator, the layout section reads out the layout template from the template storage section based on the reference information and makes the retrieved layout template substituted for or incorporated into the information storage frame setting up the reference information.

6. The layout system according to claim 4, wherein:
the layout template sets up an incorporation indicator which instructs the layout template to be incorporated; and
when the layout template sets up the incorporation indicator, the layout section reads out the layout template from the template storage section based on the reference information and makes the retrieved layout template substituted for or incorporated into the information storage frame setting up the reference information.

7. The layout system according to claim 4, wherein:
the layout section is constituted of a layout program which makes a computer execute processes implemented as the layout section; and
when an incorporation indicator which instructs the layout template to be incorporated is given as an argument, the layout program reads out the layout template from the template storage section based on the reference information and makes the retrieved layout template substituted for or incorporated into the information storage frame setting up the reference information.

8. The layout system according to claim 4, wherein:
the layout template and the posting information set up an incorporation indicator which instructs the layout template to be incorporated;
the layout section is constituted of a layout program which makes a computer execute processes implemented as the layout section;
when the incorporation indicator is set up in the layout template or the posting information or when the incorporation indicator is given as an argument, the layout program reads out the layout template from the template storage section based on the reference information and makes the retrieved layout template substituted for or incorporated into the information storage frame setting up the reference information;
the layout program assigns priorities to setting in the layout template, setting in the posting information, or setting by the argument; and
when two or more settings are made from among the setting in the layout template, setting in the posting information, and setting by the argument, the layout program adopt one of the settings made, according to the priorities.

9. The layout system according to claim 3, wherein:
the layout section regards the area identified by the size and placement location of the information storage frame setting up the reference information as the layout area, places the information storage frames prescribed by the retrieved layout template in the area by expanding or contracting them, and performs layout by storing the posting information in the placed information storage frames.

10. The layout system according to claim 3, wherein:
the layout section performs layout by expanding or contracting the information storage frames prescribed by the retrieved layout template according to the size and placement location of the information storage frame setting up the reference information and by storing the posting information in the information storage frames, and places results of the layout in the area identified by the size and placement location of the information storage frame setting up the reference information by regarding the area as the layout area.

11. The layout system according to claim 9, wherein:
processing priority is set to indicate which should be done first, the placement of the information storage frames or the storage of the posting information; and
if the layout section determines to place the information storage frames first based on the processing priority, the layout section regards the area identified by the size and placement location of the information storage frame setting up the reference information as the layout area, places the information storage frames prescribed by the retrieved layout template in the above specified area by expanding or contracting the information storage frames, and performs layout by storing the posting information in the placed information storage frames, but if the layout section determines to store the posting information first based on the processing priority, the layout section performs layout by storing the posting information in the information storage frames prescribed by the retrieved layout template, and places results of the layout in the above specified area identified by the size and placement location of the information storage frame setting up the reference information by regarding the specified area as the layout area.

12. The layout system according to claim 3, wherein:
if an appropriate layout template does not exist in the template storage section, the layout section reads out a substitute for the layout template from the template storage section.

13. The layout system according to claim 3, wherein:
the information storage frames include a character information storage frame for storing character information, for which a lower font limit is specified to indicate the lower limit of character size; and
when storing the posting information which is character information in the character information storage frame placed in the area identified by the size and placement location of the information storage frame setting up the reference information, if the lower font limit has been specified for the character information storage frame, the layout section changes the shape of the character information storage frame by changing character size in the character information storage frame so that the character size will not fall below the lower font limit.

14. The layout system according to claim 3, wherein:
the information storage frames include a character information storage frame for storing character information, for which an upper font limit is specified to indicate the upper limit of character size; and
when storing the posting information which is character information in the character information storage frame placed in the area identified by the size and placement location of the information storage frame setting up the reference information, if the upper font limit has been specified for the character information storage frame, the layout section changes the shape of the character information storage frame by changing character size in the character information storage frame so that the character size will not exceed the upper font limit.

15. The layout system according to claim 3, wherein:
if the aspect ratio of the area identified by the size and placement location of the information storage frame setting up the reference information differs from the aspect ratio of the layout area prescribed by the retrieved layout template, the layout section changes the shape of the information storage frames to be placed in the area identified by the size and placement location of the information storage frame setting up the reference information while maintaining the aspect ratio of the layout area prescribed by the retrieved layout template.

16. The layout system according to claim 3, comprising:
user information storage section for storing user information about users,
wherein the posting-information selection section selects the posting information from the posting-information storage section based on the user information in the user information storage section.

17. The layout system according to claim 3, comprising:
user information storage section for storing user information about users,
wherein the layout section lays out the posting information selected by the posting-information selection section based on the user information in the user information storage section.

18. A computer program for making a computer execute processes implemented as layout section for performing layout by storing posting information in information storage frames laid out in a predetermined layout area, according to a layout template which prescribes, for the layout area, matters concerning information storage frames, wherein:
a layout template is set up for use instead of the information storage frames or for incorporation into the information storage frames,
the layout section reads out the layout template in connection with the set up out of template storage section and makes the retrieved layout template substituted for or incorporated into the information storage frames for which the layout template has been set up.

19. A layout method comprising:
laying out posting information by storing the posting information in information storage frames laid out in a predetermined layout area, according to a layout template which prescribes matters concerning the information storage frames for the layout area;
storing the layout template in template storage section; and
setting up a layout template for use instead of the information storage frames or for incorporation into the information storage frames,
wherein laying out posting information includes reading out the layout template in connection with the set up out of the template storage section and makes the retrieved layout template substituted for or incorporated into the information storage frames for which the layout template has been set up.
